(19) United States
(12) Patent Application Publication
(10) Pub. No.: US 2025/0361101 A1
(43) Pub. Date: Nov. 27, 2025

(54) TRANSPORT MECHANISM

(71) Applicant: JAPAN CASH MACHINE CO., LTD., Osaka (JP)

(72) Inventor: Shigenori Matsushita, Osaka (JP)

(73) Assignee: JAPAN CASH MACHINE CO., LTD., Osaka (JP)

(21) Appl. No.: 18/865,984

(22) PCT Filed: Mar. 31, 2023
(86) PCT No.: PCT/JP2023/013681

§ 371 Date: Aug. 13, 2025

(30) Foreign Application Priority Data
May 30, 2022 (JP) 2022-087614

(51) Int. Cl. B65G 51/04; B65G 54/02; G07D 11/12; G07D 11/16

(52) U.S. Cl. CPC B65G 51/04; B65G 54/02; G07D 11/16; G07D 11/12; G07D 2211/00

(57) ABSTRACT

The present invention prevents a reduction of a transport force in a section where high travel energy is required. A transport path 401 includes an assistance-required section 410 in at least a portion. A banknote transport system 10 includes an assistive force application section 803 arranged adjacent to a section of an air flow path 101 along the assistance-required section, and an assistive body 900 that travels in the assistive force application section. The assistive body includes an assistive body magnet 901. The banknote transport system 10 applies an assistive travel force to a moving body 200 using a magnetic force acting between the assistive body magnet and moving body magnets 213 and indirectly assists a transport force of a transport body 500.

### FIELD

The present invention relates to a transport mechanism.

### BACKGROUND

In a game hall where various types of game machines such as pachinko machines, pachislot (pachinko-slot) machines, or slot machines are installed, game media dispensing devices for renting pachinko balls or tokens being game media to players according to the money amount of banknotes input through a banknote inlet are placed adjacent to the game machines. Various banknote transport devices (intra-bank banknote transport-related devices) are developed and installed as bank facilities to enable the game media dispensing devices to safely and smoothly collect and transport banknotes received by each of the game media dispensing devices to a cashbox.

A bank-end cashbox unit for storing and managing transported banknotes in the cashbox under secure management is installed at an end portion of each of the banknote transport devices. Development of a system for transporting collected banknotes to a cashbox without human intervention has been demanded also in game facilities, such as a casino, that handle a large amount of banknotes with the objective of preventing fraudulent acts by involved persons.

Patent Literature 1 discloses that a banknote transport device enabling a moving body to travel in an air blowing tube using an air flow and enabling a banknote transport body to travel using a magnetic force in conjunction with movement of the moving body is installed in each of bank facilities in a game hall. Since no mechanical driving means such as a motor, a gear, and a transport belt are required to cause the moving body and the transport body to travel, the durability of members constituting the transport mechanism can be increased and the running cost of the transport device can be reduced.

Patent Literature 2 discloses a transferring device including a transport tube, a moving body that has a magnet sliding inside the transport tube, an air blower that transfers the moving body, and a transported body that has a magnet attracting the magnet of the moving body and that slides on a lateral surface of the transport tube.

### CITATION LIST

### Patent Literatures

Patent Literature 1: Japanese Patent Application Laid-open No. 2020-192241
Patent Literature 2: Japanese Patent Application Laid-open No. S47-44782

### SUMMARY

### Technical Problem

A section where the transport force is reduced, in other words, a section where high travel energy is required, such as a section of a steep gradient is sometimes included in a transport route.

The speed of the moving body can be controlled by the air volume of a blower in Patent Literature 1. Therefore, when a transport target is transported in such a section, the transport target can be transported at a sufficiently high speed by increasing the output of the blower.

However, if a high output blower is adopted on the ground of such a section located in a part of the transport route, this might cause an undesired increase in the entire cost of the transport device.

Patent Literature 2 does not describe a solution to a case in which the transport force is reduced.

The present invention has been made in view of circumstances described above, and an object of the present invention is to prevent a reduction of the transport force in a section where high travel energy is required.

### Solution to Problem

In order to solve the above problem, the present invention provides a transport mechanism comprising: a moving body that has a moving body magnetic material and that travels on a moving route; a transport body that has a retaining part retaining a transport target and a transport body magnetic material, and that is transported on a transport route adjacent and parallel to the moving route in conjunction with travel of the moving body using at least a repelling force based on a magnetic force acting between the transport body magnetic material and the moving body magnetic material; an assistance-required section set in at least a portion of the transport route; an assistive force application section arranged adjacent to a section of the moving route along the assistance-required section; and an assistive body that travels in the assistive force application section, wherein the assistive body includes an assistive body magnetic material, and applies an assistive travel force to the moving body as an assistance target using a repelling force or/and an attracting force based on a magnetic force acting between the assistive body magnetic material and the moving body magnetic material.

### Advantageous Effects of Invention

According to the present invention, it is possible to prevent a reduction of the transport force in a section where high travel energy is required.

### BRIEF DESCRIPTION OF DRAWINGS

FIG. 1 is a perspective view illustrating a schematic configuration of bank facilities including a plurality of game machines.

FIG. 2 is a plan view illustrating a schematic configuration of the bank facility including a plurality of the game machines.

FIG. 3 is a schematic diagram illustrating a schematic configuration of a banknote transport system.

FIG. 4 is a vertical sectional view of a moving body, an air blowing tube including the moving body, a transport body, and a transport tube including the transport body in a case in which the moving body and the transport body repel each other due to a magnetic force.

FIGS. 5(a) to 5(c) are schematic diagrams illustrating a relation between an air blowing tube and an air-blow control unit according to one embodiment of a first invention.

FIG. 6 is a perspective view illustrating a relation between the transport tube and the transport body.

FIG. 7 is a vertical sectional view of the air blowing tube and the transport tube including the moving body and the transport body in a case in which the moving body and the transport body attract each other due to a magnetic force.

FIG. 8 is a vertical sectional view of the air blowing tube and the transport tube including the moving body and the transport body in a case in which the poles of each of moving body magnets are arranged to face in a travel direction.

FIG. 9 is a diagram illustrating a first modification of the air-blow control unit.

FIG. 10 is a diagram illustrating a second modification of the air-blow control unit.

FIG. 11 is a schematic diagram illustrating a transport mechanism according to a first embodiment of a second invention.

FIGS. 12(a) and 12(b) are schematic diagrams illustrating an arrangement example of magnets.

FIG. 13 is a schematic diagram illustrating a transport mechanism according to a second embodiment of the second invention.

FIGS. 14(a) and 14(b) are schematic diagrams illustrating an arrangement example of magnets.

FIGS. 15(a) to 15(c) are schematic diagrams for explaining a drive example of an assistive body.

FIG. 16 is a schematic diagram illustrating another configuration and drive example of the assistive body.

FIG. 17 are schematic diagrams illustrating a first example in which the assistive body is linearly driven.

FIG. 18 is a schematic diagram illustrating a second example in which the assistive body is linearly driven.

### DESCRIPTION OF EMBODIMENTS

The present invention will be described below in detail with embodiments illustrated in the drawings. Constituent elements, types, combinations, shapes, and relative arrangements described in the following embodiment are merely explanatory examples, and are not intended to limit the scope of the present invention solely thereto unless otherwise specified. Configurations described in the following embodiments can be combined with each other as appropriate in a range without any mutual contradiction.

Embodiments of the present invention are described below in detail.

### A. Paper Sheet Transport System According to First Invention

A basic configuration and an operation of a paper sheet transport system according to a first invention are explained below.

The paper sheet transport system is installed on each of bank facilities in a game hall where various types of game machines such as pachinko machines or pachislot (pachinko-slot) machines are installed. Although banknotes are mainly explained as an example of paper sheets in the following embodiment, the present invention is also applicable to paper sheets (sheets) other than the banknotes, including securities such as cash vouchers or gift certificates, cards, and the like.

Although not particularly illustrated or explained, the paper sheet transport system according to the present invention is also applied to a banknote transport system or a banknote transport device in casinos.

### [Schematic Configuration of Bank Facilities]

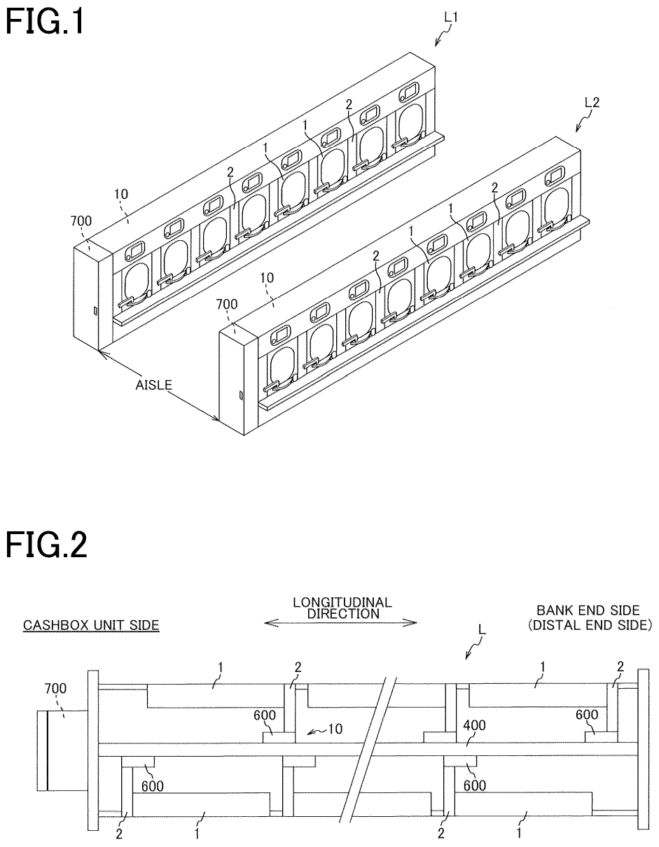

FIG. 1 is a perspective view illustrating a schematic configuration of bank facilities including a plurality of game machines.

Game machines 1 are installed on bank facilities L (L1, L2, . . . ) and eight game machines 1 are arranged back to back on each of two opposing side surfaces of each of the bank facilities L, that is, a total of 16 game machines 1 are arranged back to back. An aisle on which players or clerks of the game hall walk is provided between the bank facilities L and a chair (not illustrated) is provided for each of the game machines 1 on the aisles.

A sandwiched machine 2 is installed for each of the game machines 1 on the bank facilities L. The sandwiched machine 2 includes a banknote inlet (a banknote input part) that receives input banknotes, a game media dispensing device that dispenses a number of pachinko balls corresponding to the money amount of input banknotes, and the like. A banknote transport system 10 that transports banknotes inserted through the sandwiched machines 2 to a cashbox unit 700 placed at one end portion of the associated 30 bank facility L is installed in each of the bank facilities L illustrated in FIG. 1.

FIG. 2 is a plan view illustrating a schematic configuration of the bank facility including a plurality of the game machines.

The banknote transport system 10 installed in each of the bank facilities L includes receiving units (banknote receiving devices) 600 that each receive banknotes inserted from the banknote inlet of the associated sandwiched machine 2 therein, a transport tube 400 that extends in a longitudinal direction of the bank facility L (an array direction of the game machines 1) and that transports the banknotes received by the receiving units 600, the cashbox unit 700 that is arranged at one end of the transport tube 400, and the like.

### [Schematic Configuration of Banknote Transport System]

### <Overall Outline>

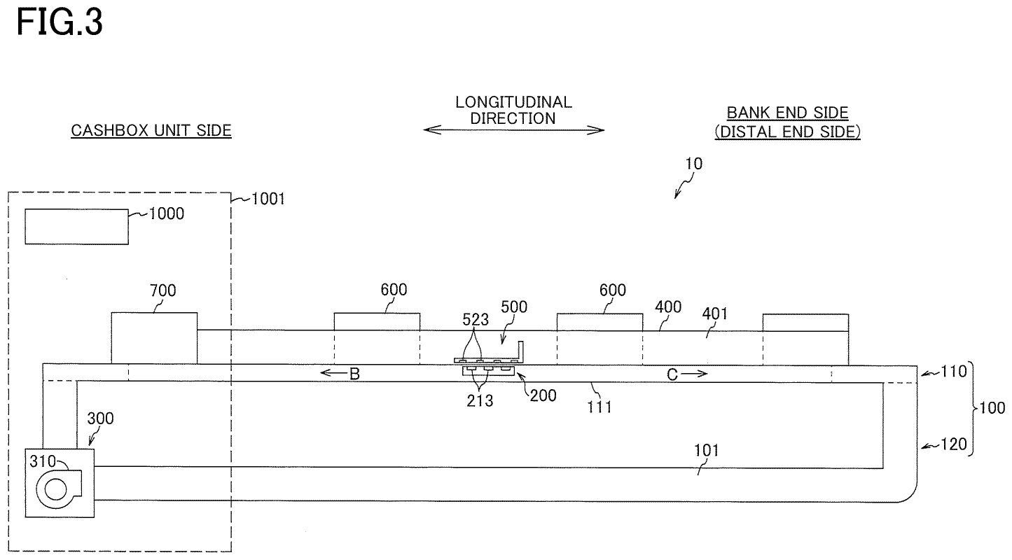

FIG. 3 is a schematic diagram illustrating a schematic configuration of the banknote transport system. The banknote transport system (paper sheet transport mechanism) 10 according to one embodiment of the first invention is characterized in transporting banknotes using an air flow and a magnetic force.

The banknote transport system 10 includes an air blowing tube 100 that forms a flow path (an air flow path 101) of a gas, a moving body 200 that travels (moves) inside the air blowing tube 100 while receiving an air flow flowing in a predetermined direction within the air blowing tube 100, an air-blow control unit 300 that controls the air flow flowing inside the air blowing tube 100, the transport tube 400 (a transport path 401) that has at least a portion arranged along the air blowing tube 100 to be adjacent to the air blowing tube 100, and a transport body 500 that is configured to be able to retain banknotes (paper sheets) and that travels (moves) inside the transport tube 400. The transport tube 400 forms the transport path 401 (a banknote (paper sheet) transport route and a transport space) for banknotes.

The moving body 200 includes a moving body magnetic material (moving body magnets 213), and the transport body 500 includes a transport body magnetic material (transport body magnets 523). At least one of the moving body magnetic material and the transport body magnetic material is formed of a magnet.

The banknote transport system 10 includes the receiving units 600 that receive banknotes input from outside and keep the banknotes at predetermined locations in the transport tube 400, respectively, the cashbox unit 700 that includes a banknote accommodating part that accommodates therein banknotes transported by the transport body 500, and a management unit (control means) 1000 that controls the components constituting the banknote transport system 10.

In the present example, the air-blow control unit 300 and the cashbox unit 700 are accommodated in a housing 1001 that has the management unit 1000 housed therein.

The banknote transport system 10 is characterized in moving the moving body 200 arranged in the air blowing tube 100 back and forth in the longitudinal direction of the air blowing tube 100 with the air flow flowing inside the air blowing tube 100, and in moving the transport body 500 arranged in the transport tube 400 along the longitudinal direction of the air blowing tube 100 with a magnetic force acting between the transport body 500 and the moving body 200. That is, the banknote transport system 10 is characterized in moving the transport body 500 in conjunction with movement of the moving body 200 receiving the air flow due to attraction and/or repulsion based on a magnetic force acting between the moving body magnets 213 and the transport body magnets 523.

### <Outline of Components>

The air blowing tube 100 includes a moving route part 111 in at least a portion in the longitudinal direction, on which the moving body 200 travels along the longitudinal direction of the air blowing tube 100. The moving route part 111 is arranged in parallel and adjacent to the transport tube 400.

The moving body 200 moves inside the air blowing tube 100 while receiving an air flow flowing in a predetermined direction within the air blowing tube 100. The moving body magnets 213 mounted on the moving body 200 provide a repelling action and/or an attracting action due to a magnetic force to the transport body 500. The moving body 200 moves the moving body 200 in conjunction with its own movement due to the magnetic force.

The air-blow control unit 300 includes a blower (an air flow generating device) 310 that generates (produces) an air flow in a predetermined direction inside the air blowing tube 100 and that can change the flow volume and the flow speed of the air flow. The air-blow control unit 300 alternately generates an air flow in a first direction (a banknote collecting direction and an arrow-B direction) and an air flow in a second direction (a transport body returning direction and an arrow-C direction) being an opposite direction to the first direction inside the air blowing tube 100 to reciprocate the moving body 200 inside the air blowing tube 100.

The transport tube 400 forms a space through which banknotes and the transport body 500 move.

The transport body 500 receives the banknotes kept at the predetermined locations in the transport path 401 to retain the banknotes in an upright state, and moves inside the transport path 401 to transport the banknotes to the cashbox unit 700. The transport body magnets 523 mounted on the transport body 500 are subjected to the attracting action and/or the repelling action due to the magnetic force from the moving body magnets 213 included in the moving body 200. The transport body 500 moves inside the transport tube 400 in conjunction with the movement of the moving body 200 receiving the air flow.

When only the attracting force is to be applied between the moving body 200 and the transport body 500, both the magnetic materials mounted on the moving body 200 and the transport body 500 can be magnets, or one of the magnetic materials of the moving body 200 and the transport body 500 may be magnets and the other one may be a magnetic material such as iron. When only the repelling force is to be applied between the moving body 200 and the transport body 500, both the magnetic materials mounted on the moving body 200 and the transport body 500 are formed of magnets.

The receiving unit (banknote receiving device) 600 receives banknotes inserted from the banknote inlet (a banknote inserting part) of the associated sandwiched machine 2 therein and keeps the banknotes at a predetermined location in the transport path 401. The receiving unit 600 is provided for each of the sandwiched machines 2. A plurality of the receiving units 600 are installed in the longitudinal direction of the transport tube 400 at a predetermined interval.

The cashbox unit 700 includes a banknote accommodating part that accommodates therein banknotes transported by the transport body 500, a drive mechanism that drives members related to accommodation of the banknotes in the banknote accommodating part, and the like.

The management unit (control means) 1000 controls operations of the components constituting the banknote transport system 10. The management unit 1000 is configured to include a general computer device that includes a CPU (Central Processing Unit), a ROM (Read Only Memory), a RAM (Random Access Memory), and the like and in which these units are connected via a bus. The CPU is an arithmetic unit that controls the entire banknote transport system 10. The ROM is a nonvolatile memory that has a control program to be executed by the CPU, data, and the like stored therein. The RAM is a volatile memory to be used as a work area for the CPU. The CPU reads the control program stored in the ROM to load the control program into the RAM and execute the control program, so that various functions are realized.

### [Detailed Configuration of Banknote Transport System]

Detailed configurations of the components of the banknote transport system according to the embodiment of the first invention are explained.

### <Air Blowing Tube>

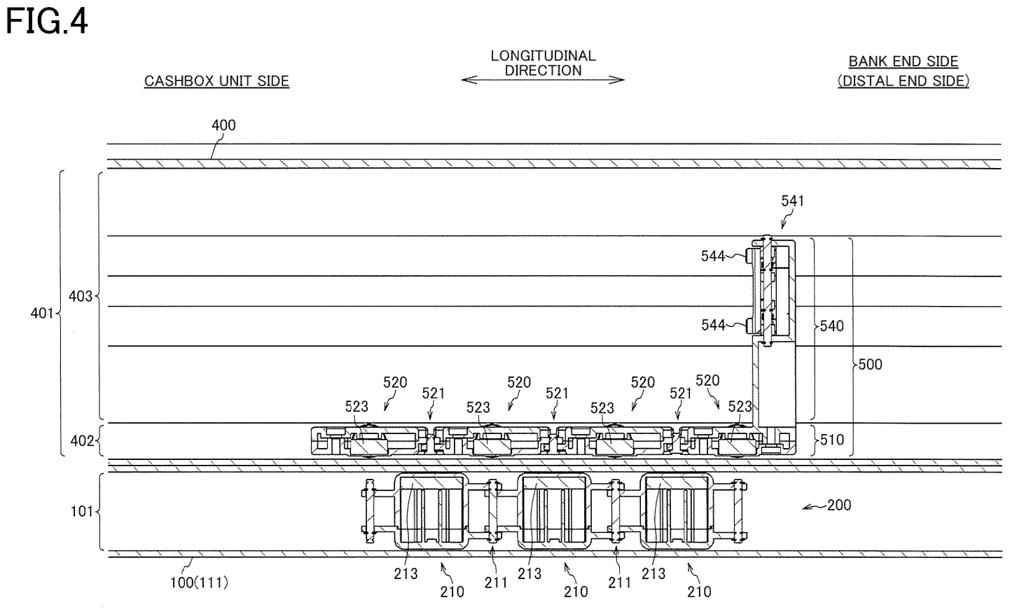

The air blowing tube is explained with reference to FIGS. 3 and 4.

FIG. 4 is a vertical sectional view of the moving body, the air blowing tube including the moving body, the transport body, and the transport tube including the transport body in a case in which the moving body and the transport body repel each other due to a magnetic force.

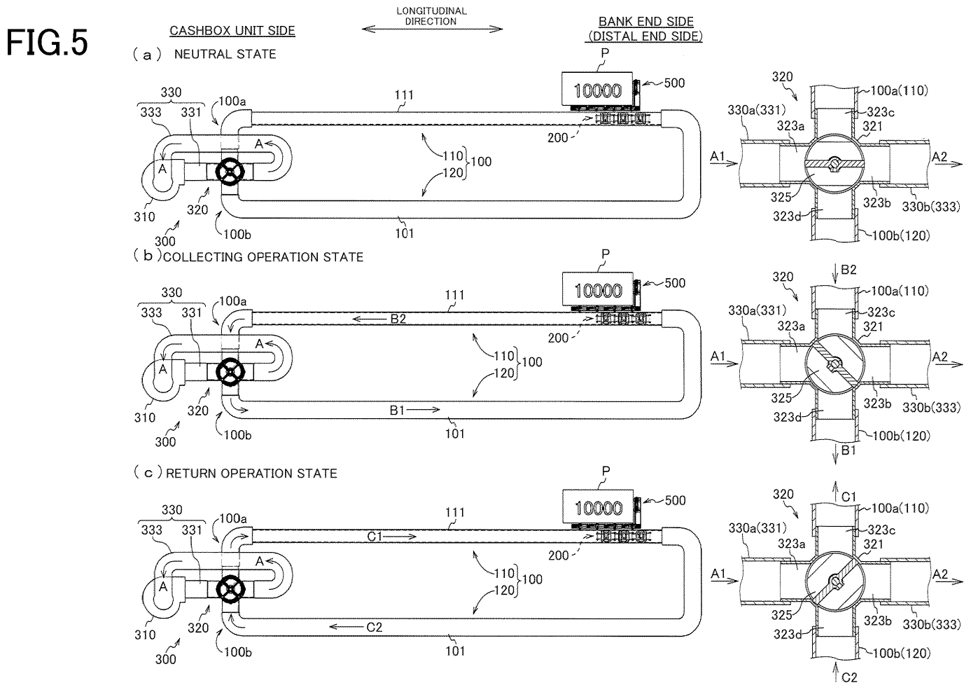

The air blowing tube 100 illustrated in FIG. 3 includes a first air blowing tube 110 including the moving route part 111, and a second air blowing tube 120 forming the air flow path 101 in an endless manner with the first air blowing tube 110 through a switching valve 325 (see FIG. 5), which will be described later.

Since the banknote transport system 10 moves the transport body 500 using a magnetic force, the moving route part 111 of the air blowing tube 100 includes a configuration that does not affect the travel of the moving body 200 and the travel of the transport body 500 based on the magnetic force. While it is desirable that the moving route part 111 is entirely formed of a non-magnetic material, the moving route part 111 may include a magnetic material in a portion within a range that does not affect the travel of the moving body 200 and the transport body 500.

The moving route part 111 includes a configuration (the thickness of the tube, the spacing between the tubes, the shape thereof, and the like) that can apply a magnetic force between the moving body 200 arranged inside the moving route part 111 and the transport body 500 arranged inside the transport tube 400.

With the configuration of the air blowing tube 100 separate from and independent of the transport tube 400, an airtight flow path can be formed in the air blowing tube 100. Reduction in the transport force of the moving body 200 due to air leakage to outside of the air blowing tube 100 can be prevented. Furthermore, the blower 310 being relatively inexpensive and outputting low power can be adopted as a blower to be used to generate an air flow and reduction in the cost of the banknote transport system 10 can be realized. The air flow inside the air blowing tube 100 can be reliably controlled even when the air blowing tube 100 is elongated with an increase in the banknote transport distance. Since the moving body 200 is caused to travel with the air flow, the need to arrange a mechanical configuration such as a gear or a transport belt, lines, or electrical contacts inside the air blowing tube 100 is eliminated and the durability of the air blowing tube 100 and the moving body 200 arranged therein is increased. Furthermore, external air does not flow in the air flow path 101 airtightly configured, so that grit and dust in the external air are not drawn therein and the inside of the air flow path 101 can be kept clean.

### <Moving Body>

It suffices that the moving body 200 has a shape and a configuration that enable movement in the air blowing tube 100 by being subjected to an air pressure.

As illustrated in FIG. 4, the moving body 200 has a configuration in which a plurality of divided pieces 210, 210, . . . are sequentially coupled to each other with hinge parts 211 along a travel direction of the moving body 200 (the longitudinal direction of the air blowing tube 100). The divided pieces 210 illustrated in the present example have same configurations and each of the divided pieces 210 has the moving body magnet 213.

The moving body 200 includes the moving body magnets 213 respectively arranged at locations, in attitudes, and in shapes that enable to apply a magnetic force to the transport body 500. In the present example, the moving body magnets 213 are arranged on a side of the moving body 200 nearer the transport tube 400. The moving body magnets 213 included in the moving body 200 are arranged spaced apart from each other in the travel direction of the moving body 200. In the present example, each of the moving body magnets 213 is attached to the associated divided piece 210 in such a manner that the N pole (one of the poles) faces the side of the transport tube 400 (the upper side in FIG. 4) and the S pole (the other pole) faces the lower side in FIG. 4.

The moving body 200 illustrated in the present example is constituted of three divided pieces 210. The divided pieces 210 are coupled to each other to be angularly displaceable within a predetermined range in the upper-lower direction in FIG. 4 and the depth direction of the plane of the paper centering on the hinge parts 211, respectively. With this configuration, the moving body 200 can smoothly move in the air blowing tube 100 while the divided pieces 210 displace even when the air blowing tube 100 forms the air flow path 101 curved in the upper-lower or right-left direction.

### <Relation Between Air Blowing Tube and Moving Body>

The inner surface shape of the moving route part 111 and the outer surface shape (structure) of the moving body 200 are formed in such a manner that the moving body 200 does not relatively rotate on a virtual axis extending along the longitudinal direction of the moving route part 111 with respect to the moving route part 111. For example, the horizontal sectional shape (the shape on a cross section orthogonal to the longitudinal direction) of the moving route part 111 and the horizontal sectional shape of the divided pieces 210 of the moving body 200 are respectively formed into rectangular shapes. With provision of the configuration described above, the attitude of the moving body 200 in the moving route part 111 can be maintained to cause the N pole (one of the poles) of each of the moving body magnets 213 to always face the side of the transport tube 400.

### <Air-Blow Control Unit>

FIGS. 5(a) to 5(c) are schematic diagrams illustrating a relation between the air blowing tube and the air-blow control unit according to one embodiment of the first invention.

The air-blow control unit 300 according to the present embodiment includes a single blower 310 that generates an air flow flowing in a certain direction, and a switching unit 320 (the switching valve 325) that controls the direction of the air flow in the air blowing tube 100. The air-blow control unit 300 is characterized in switching the direction of the air flow in the air blowing tube 100 between the first direction (the banknote collecting direction and the arrow-B direction) and the second direction (the moving body returning direction and the arrow-C direction) opposite to the first direction using the switching unit 320.

The air-blow control unit (an air-flow control device) 300 includes the switching unit (an air flow switching unit) 320 that controls the discharge direction of the air flow, a first circulation pipe 330 that forms an endless air flow path through the switching unit 320, and the blower 310 that is arranged at an appropriate place in the first circulation pipe 330 to generate an air flow flowing in a certain direction inside the first circulation pipe.

The switching unit 320 includes a casing 321 in which four flow paths 323 (a first flow path 323a to a fourth flow path 323d: ports) respectively connecting to external pipes are formed, and the switching valve 325 that is arranged in a joint portion (an intersecting portion) of the four flow paths 323 to switch the communication state among the flow paths 323 and/or the opening degrees at the time of communication. The flow paths 323 are communicated with and connected to an air discharge tube 331, an air intake tube 333, the first air blowing tube 110, and the second air blowing tube 120 that are external pipes, respectively. In the present example, the flow paths 323 are arranged in a cross manner (a radial manner). The switching valve 325 illustrated in the present example is a rotary valve such as a ball valve and the switching valve 325 rotates in the casing 321 by a predetermined angle, whereby the communication states of the flow paths 323 and the opening degrees of the flow paths 323 are switched.

The switching valve 325 is an electric-operated valve and is driven by a motor to control the rotation angle. For example, a stepping motor can be used as the motor. The switching valve 325 is, for example, controlled to have a desired rotation angle by the management unit 1000 that controls the rotation angle of the stepping motor on the basis of a drive pulse. Of course, other methods may be used for driving means for rotating the switching valve 325 and control of the rotation angle of the switching valve 325. For example, a configuration in which a rotary encoder that rotates in conjunction with the switching valve 325, and a sensor that detects the rotation angle of the rotary encoder are mounted on the switching unit 320 and in which the management unit 1000 executes feedback control of the rotation angle of the switching valve 325 may be adopted.

The first circulation pipe 330 includes the air discharge tube 331 that has one end portion (one end portion 330a of the first circulating pipe 330) communicatively connected to the first flow path 323a of the switching unit 320 and the other end portion communicatively connected to the outlet of the blower 310, and the air intake tube 333 that has one end portion communicatively connected to the inlet of the blower 310 and the other end portion (the other end portion 330b of the first circulation pipe 330) communicatively connected to the second flow path 323b of the switching unit 320.

The air blowing tube (the second circulation pipe) 100 has one end portion 100a communicatively connected to the third flow path 323c of the switching unit 320 and the other end portion 100b communicatively connected to the fourth flow path 323d of the switching unit 320, and forms an endless air flow path through the switching unit 320. The air blowing tube 100 reciprocates the moving body 200 placed therein in the arrow-B direction and the arrow-C direction in FIG. 5 with the air flow.

The air blowing tube 100 according to the present example includes the first air blowing tube 110 forming the moving route part 111 of the moving body 200, and the second air blowing tube 120 communicatively connected to the first air blowing tube 110. The first air blowing tube 110 is communicatively connected to the third flow path 323c and the second air blowing tube 120 is communicatively connected to the fourth flow path 323d.

### <<Operation of Switching Unit: Neutral State>>

FIG. 5(a) illustrates a neutral state.

The switching valve 325 is in a neutral position for establishing communication between the first flow path 323a and the second flow path 323b while not establishing communication between the first and second flow paths 323a and 323b and the third and fourth flow paths 323c and 323d.

Accordingly, the air flow circulates in the first circulation pipe 330 in an arrow-A (A1 and A2) direction and no air flow is generated inside the air blowing tube 100. Therefore, the moving body 200 is in a state stopped in the air blowing tube 100.

### <<Operation of Switching Unit: First Communication State>>

FIG. 5(b) illustrates a first state in which an air flow flowing in the first direction (an arrow-B1 or B2 direction) is generated inside the air blowing tube 100. This state is, for example, a banknote collecting operation state for transporting banknotes collected by the transport body 500 to the cashbox unit 700.

The switching valve 325 is in a first communication position for establishing communication between the first flow path 323a and the fourth flow path 323d and establishing communication between the second flow path 323b and the third flow path 323c. At this time, the first flow path 323a and the fourth flow path 323d are not communicated with the second flow path 323b and the third flow path 323c.

The air circulates in an endless manner between the first circulation pipe 330 and the air blowing tube 100. That is, air (in the arrow-A1 direction) discharged from the discharge tube 331 to flow in the first flow path 323a flows in the second air blowing tube 120 from the fourth flow path 323d (in the arrow-B1 direction) due to the switching valve 325. Air flowing in the arrow-B2 direction inside the first air blowing tube 110 to flow in the third flow path 323c flows in the intake tube 333 from the second flow path 323b (in the arrow-A2 direction) due to the switching valve 325, returns to the blower 310, and is discharged again from the discharge tube 331.

### <<Operation of Switching Unit: Second Communication State>>

FIG. 5(c) illustrates a second state in which an air flow flowing in the second direction (an arrow-C1 or C2 direction) is generated inside the air blowing tube 100. This state is, for example, a return operation state for returning the transport body 500 from the side of the cashbox unit 700 (the side of the management unit 1000) to the distal end side of the transport tube 400.

The switching valve 325 is in a second communication position for establishing communication between the first flow path 323a and the third flow path 323c and establishing communication between the second flow path 323b and the fourth flow path 323d. At this time, the first flow path 323a and the third flow path 323c are not communicated with the second flow path 323b and the fourth flow path 323d.

The air circulates in an endless manner between the first circulation pipe 330 and the air blowing tube 100. That is, air (in the arrow-A1 direction) discharged from the discharge tube 331 to flow in the first flow path 323a flows in the first air blowing tube 110 from the third flow path 323c (the arrow-C1 direction) due to the switching valve 325. Air flowing in the arrow-C2 direction inside the second air blowing tube 120 to flow in the fourth flow path 323d flows in the intake tube 333 from the second flow path 323b (in the arrow-A2 direction) due to the switching valve 325, returns to the blower 310, and is discharged again from the discharge tube 331.

### <<Operation of Switching Unit: Summary>>

By connecting two endless pipes (the first circulation pipe 330 and the air blowing tube 100) via the switching unit 320 as described above, three states including the neutral state in which no air flow is generated in the air blowing tube 100, the first communication state in which an air flow flowing in the first direction (the arrow-B direction) is generated inside the air blowing tube 100, and the second communication state in which an air flow flowing in the second direction (the arrow-C direction) is generated inside the air blowing tube 100 can be changed by changing the position of the switching valve 325 while an air flow in a certain direction (the arrow-A direction) is generated by the single blower 310.

In intermediate positions taken by the switching valve 325 among the three positions described above, the communication state changes from those in the three states. That is, since the communication relation among the flow paths and the opening degrees of the flow paths can be adjusted according to the angle of the switching valve 325 in the casing 321 in the present embodiment, an air volume of the air flow according to the opening degrees of the flow paths can be generated inside the air blowing tube 100. That is, the speed of the moving body 200 can be varied according to the wind speed in the air blowing tube 100.

The moving speed of the moving body 200 may be adjusted by control of the air volume of the blower 310. For example, the air volume of the blower 310 may be adjusted by varying the rotational speed of blades of the blower 310 by PWM (Pulse Width Modulation) control. However, since the rotation responsiveness of the switching valve 325 is higher than the variation responsiveness of the rotational speed of the blower 310, adjustment of the rotation angle of the switching valve 325 is more advantageous to rapidly adjust the speed of the moving body 200.

### <Transport Tube>

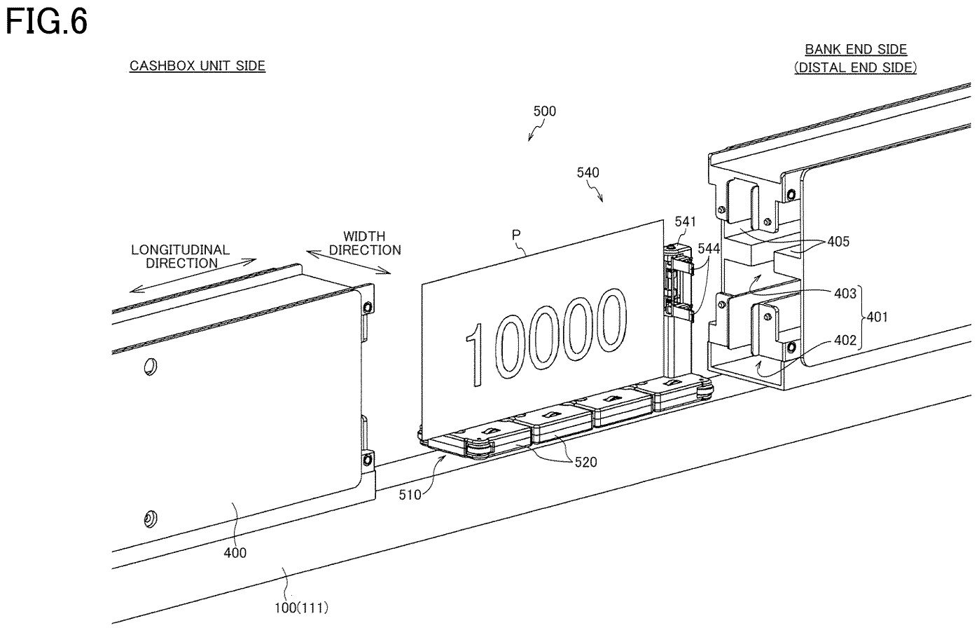

The transport tube (the transport route) 400 is explained with reference to FIGS. 4 and 6.

FIG. 6 is a perspective view illustrating a relation between the transport tube and the transport body. FIG. 6 illustrates a state in which the inner part of the transport tube 400 is partially exposed.

Since the transport body 500 is transported with a magnetic force in the banknote transport system 10, the transport tube 400 is formed of a material that does not affect the travel of the transport body 500 based on the magnetic force. Although it is desirable that the transport tube 400 is entirely formed of a non-magnetic material, the transport tube 400 may include a magnetic material in a part thereof without affecting the travel of the transport body 500.

The transport tube 400 includes a configuration (the thickness of the tube, the spacing between tubes, the shape thereof, and the like) that can apply a magnetic force between the moving body 200 arranged inside the moving route part 111 and the transport body 500 arranged inside the transport tube 400.

Although the transport tube 400 is arranged above the air blowing tube 100 in the present example, the location relation between the air blowing tube 100 and the transport tube 400 is not limited thereto. The transport tube 400 may be arranged below the air blowing tube 100 or the transport tube 400 may be arranged on the lateral side of the air blowing tube 100.

While the transport tube 400 is illustrated as means that constitutes the transport path 401 in the present example, the means that constitutes the transport path 401 does not need to be tubular and the present invention can be achieved even with a configuration in which a part or the whole of the transport path 401 is open to outside. That is, the transport tube 400 can have any form when it can form an elongated space as the transport path 401 therein.

### <Transport Body>

As illustrated in FIGS. 4 and 6, the transport body 500 includes a transport base 510 that is arranged on the side nearer the air blowing tube 100 in the transport path 401 and that is subjected to a magnetic force from the moving body 200, and a banknote collecting/retaining part 540 provided on the opposite side of the transport base 510 to the air blowing tube 100.

### <<Transport Base>>

The transport base 510 has a configuration in which a plurality of divided pieces 520, 520, . . . are sequentially coupled to each other with hinge parts 521 along the travel direction of the transport body 500 (the longitudinal direction of the transport tube 400). Each of the divided pieces 520 illustrated in the present example includes the transport body magnet 523.

The transport base 510 includes the transport body magnets 523 arranged at locations, in attitudes, and in shapes that can be subjected to the effect of the magnetic force from the moving body 200. In the present example, the transport body magnets 523 are arranged on the side of the transport base 510 nearer the air blowing tube 100. The transport body magnets 523 included in the transport base 510 are arranged spaced apart from each other in the travel direction of the transport body 500. In the present example, each of the transport body magnets 523 is attached to the associated divided piece 520 in such a manner that the N pole (one of the poles) faces the side of the air blowing tube 100 (the lower side in FIGS. 4 and 6) and the S pole (the other pole) faces the upper side in FIGS. 4 and 6. The transport base 510 magnetically levitates in the transport tube 400 under a repelling force due to the magnetic force from the moving body 200.

The transport base 510 illustrated in the present example is constituted of four divided pieces 520. The divided pieces 520 are coupled to each other to be angularly displaceable within a predetermined range in the upper-lower direction in FIGS. 4 and 6 and the depth direction of the plane of paper centering on the hinge parts 521, respectively. With the configuration described above, the transport body 500 can smoothly move in the transport tube 400 even when the transport tube 400 forms the transport path 401 curved in the upper-lower or right-left direction.

### <<Banknote Collecting/Retaining Part>>

The banknote collecting/retaining part 540 is arranged on the transport base 510. The banknote collecting/retaining part 540 includes a support member 541 that is upright in a direction away from the air blowing tube 100, and collecting members (collecting pawls) 544 that are protruded from the support member 541 in the width direction at an end portion on the bank end side in the longitudinal direction of the transport tube 400 (on the distal end side with respect to the cashbox unit 700). The support member 541 is protruded upward from a middle portion of the transport base 510 in the width direction.

The banknote collecting/retaining part 540 retains banknotes P to cause the long edge direction of the banknotes P to follow the longitudinal direction of the transport tube 400 and in an upright attitude. One of long sides (a long side positioned on the lower side in FIG. 6) of the banknote P is supported by the transport base 510. The rear end edge (one of short sides) of the banknote is supported by the support member 541 or the collecting members 544.

### <Relation Between Transport Tube and Transport Body>

The transport tube 400 includes therein a base transport path 402 arranged on the side nearer the air blowing tube 100, and a banknote transport path 403 arranged on the opposite side to the air blowing tube 100. The base transport path 402 is a horizontally-long space where the transport base 510 of the transport body 500 travels, and the banknote transport path 403 is a vertically-long space where the banknote collecting/retaining part 540 of the transport body 500 and banknotes retained by the banknote collecting/retaining part 540 travel.

Since the transport body 500 illustrated in the present example travels while being subjected to a repelling force due to a magnetic force from the moving body 200, the base transport path 402 and the transport base 510 are configured to inhibit separation (movement toward the banknote transport path 403) of the transport base 510 from the base transport path 402 and to maintain the transport base 510 at a location where the effect of the magnetic force can be received from the moving body 200.

The inner surface shape of the base transport path 402 and the outer surface shape of the transport base 510 are formed in such a manner that the transport base 510 does not relatively rotate on a virtual axis extending along the longitudinal direction of the base transport path 402 with respect to the base transport path 402. For example, the horizontal sectional shape of the base transport path 402 and the horizontal sectional shape of the transport base 510 are formed in rectangular shapes. With provision of the configuration described above, the attitude of the moving body 200 in the base transport path 402 is maintained to cause the N pole (one of the poles) of each of the transport body magnets 523 to always face the side of the air blowing tube 100.

### <Relation Between Moving Body and Transport Body>

A relation between the moving body magnetic material and the transport body magnetic material is explained.

### <<Only Repulsion>>

As illustrated in FIG. 4, one or more magnets can be arranged in both the moving body 200 and the transport body 500 in directions repelling each other to apply only the repelling force between the moving body 200 and the transport body 500. When only the repelling force is to be applied between the moving body 200 and the transport body 500, it is desirable that a plurality of magnets are arranged on at least one of the moving body 200 and the transport body 500 at a predetermined interval in the travel direction. With arrangement of the magnets in the travel direction on at least one of the moving body 200 and the transport body 500, the moving body magnets 213 and the transport body magnets 523 are alternately arrayed when the moving body 500 travels while being subjected to the repelling force from the moving body 200. That is, when the transport body 500 travels, the transport body 500 is relatively positioned with respect to the moving body 200. In this case, it is particularly preferable that the difference between the number of magnets included in the moving body 200 and the number of magnets included in the transport body 500 is one. In other words, when n is a natural number, it is preferable that n magnets are arranged on one of the moving body 200 and the transport body 500 and that n+1 magnets are arranged on the other one.

When the transport tube 400 is placed above the air blowing tube 100 and a repelling force is applied between the transport body 500 and the moving body 200, the transport body 500 levitates in the transport tube 400 and therefore the transport body 500 is less likely to be in contact with the transport tube 400. Accordingly, it is possible to prevent reduction in the transport force of the transport body 500 due to friction with the transport tube 400 and smoothly move the transport body 500. Since the contact between the transport body 500 and the transport tube 400 is suppressed, generation of fine dust (powdery dust) due to contact between members can be prevented.

When the repelling force is applied between the moving body 200 and the transport body 500, the transport force can be increased by increasing the number of magnets included in the moving body 200 and the transport body 500.

### <<Only Attraction>>

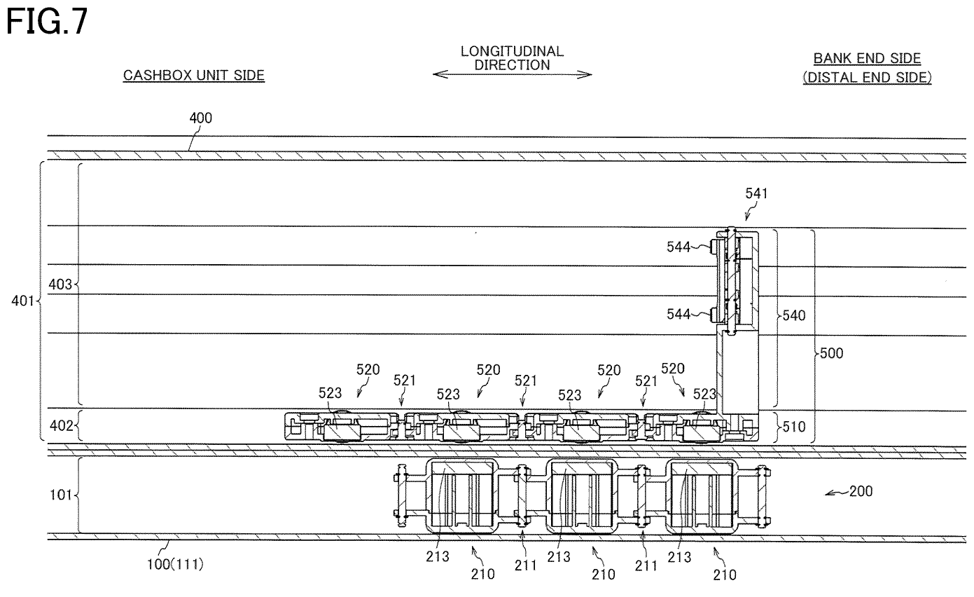

FIG. 7 is a vertical sectional view of the air blowing tube and the transport tube including the moving body and the transport body in a case in which the moving body and the transport body attract each other due to a magnetic force.

In an illustrated example, the moving body magnets 213 and the transport body magnets 523 are respectively attached to the moving body 200 and the transport body 500 in attitudes attracting each other. Since the locations in the longitudinal direction of the moving body magnets 213 and the transport body magnets 523 match each other with walls of the air blowing tube 100 and the transport tube 400 interposed therebetween, positioning of the transport body 500 with respect to the moving body 200 is easy.

When only the attracting force based on the magnetic force is to be applied between the moving body 200 and the transport body 500, it suffices that at least either the magnetic material mounted on the moving body 200 or the magnetic material mounted on the transport body 500 is a magnet. For example, magnets may be arranged on one of the transport body 500 and the moving body 200 and a magnetic material (for example, iron plates), other than magnets, that is attracted by magnets may be arranged on the other one.

When only the attracting force based on the magnetic force is to be applied between the moving body 200 and the transport body 500, it suffices that at least one set of magnetic materials (for example, a set of a magnet and a magnet or a set of a magnet and an iron plate) is arranged on the transport body 500 and the moving body 200.

### <<Repulsion and Attraction>>

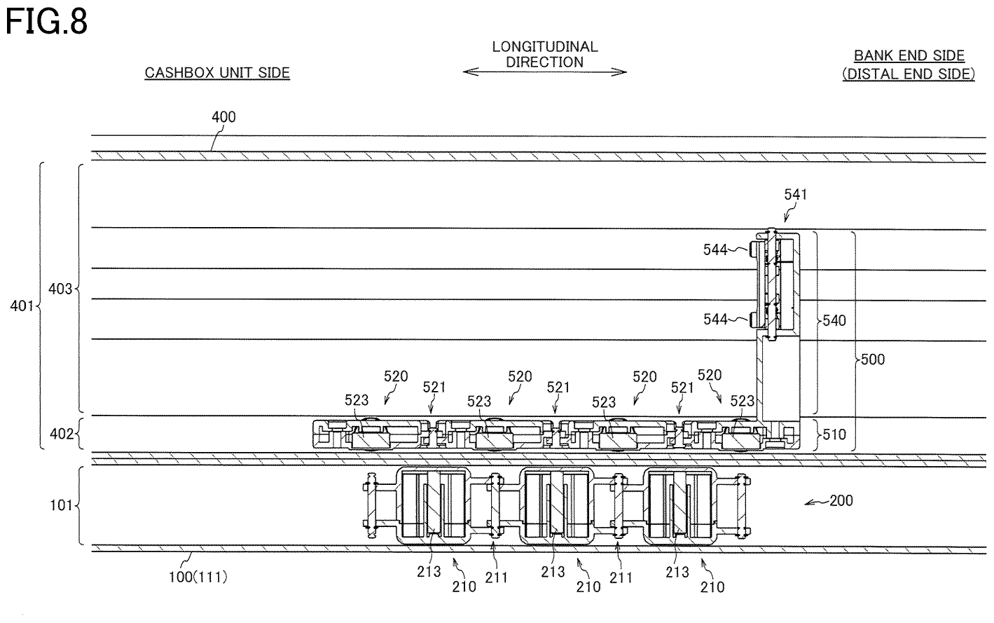

Both the repelling force and the attracting force may be applied between the moving body 200 and the transport body 500. That is, a set of magnets that apply a repelling force to each other, and a set of magnets that apply an attracting force to each other may be mixed on the moving body 200 and the transport body 500. An example in which both the repelling force and the attracting force are applied will be described later with reference to FIG. 8.

### <<Orientation of Magnets>>

While the poles of each of the magnets are arranged to face in the upper-lower direction (a staking direction of the air blowing tube 100 and the transport tube 400) in the embodiment described above, the poles of each of the magnets may be arranged to face in the travel direction (for example, to cause the N pole to face toward the cashbox unit and the S pole to face toward the bank end side/the distal end side). Alternatively, the poles of each of the magnets may be arranged diagonally to the travel direction. The action of the magnetic force can be appropriately adjusted according to the orientation of the magnets.

### <<Orientation of Magnets: Arrangement in Tandem>>

FIG. 8 is a vertical sectional view of the air blowing tube and the transport tube including the moving body and the transport body in a case in which the poles of each of the moving body magnets are arranged to face in the travel direction.

In an illustrated example, each of the moving body magnets 213 is attached to the associated divided piece 210 in such a manner that the N pole (one of the poles) faces the side of the cashbox unit (the left side in FIG. 8) and the S pole (the other pole) faces the distal end side (the right side in FIG. 8). Each of the transport body magnets 523 is attached to the associated divided piece 520 in such a manner that the N pole faces the side of the air blowing tube 100 and the S pole faces the upper side in FIG. 8.

Since surfaces (the N poles) on the cashbox unit side of the moving body magnets 213 respectively repel the transport body magnets 523 (the N poles), and the surfaces (the S poles) on the distal end side of the moving body magnets 213 respectively attract the transport body magnets 523 (the N poles), both the repelling force and the attracting force can be applied between the moving body 200 and the transport body 500.

### [First Modified Embodiment Related to Air Blow Control]

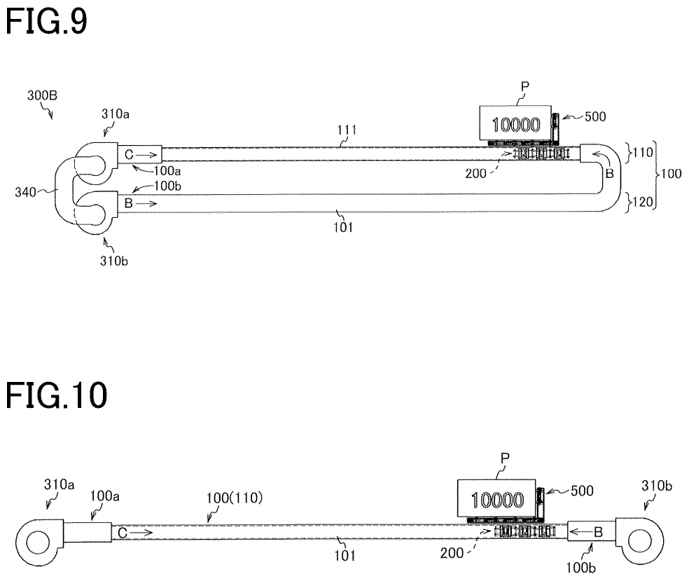

FIG. 9 is a diagram illustrating a first modification of the air-blow control unit. An air-blow control unit 300B may have a configuration including a blower 310a having an outlet connected to one end portion 100a of the air blowing tube 100, a blower 310b having an outlet connected to the other end portion 100b of the air blowing tube 100, and a connection pipe 340 that connects inlets of the blowers 310a and 310b to each other. The air blowing tube 100 (the first air blowing tube 110 and the second air blowing tube 120) is configured in an endless manner through the two blowers 310a and 310b and the connection pipe 340.

Turning on/off of the blowers 310a and 310b and the air volume thereof are controlled by the management unit 1000.

When an air flow flowing in a first direction (an arrow-B direction) is to be generated inside the air blowing tube 100 (the first state and the banknote collecting operation state), one blower 310b is turned on to generate an air flow and the other blower 310a is turned off. Air flowing inside the air blowing tube 100 flows in the outlet of the blower 310a and is discharged from the inlet of the blower 310a. The air further passes through the connection pipe 340 to return to the inlet of the blower 310b and is discharged from the outlet of the blower 310b.

When an air flow flowing in a second direction (an arrow-C direction) is to be generated inside the air blowing tube 100 (the second state and the transport body returning state), it suffices to turn one blower 310b off and turn the other blower 310a on to generate the air flow.

In this manner, the use of two blowers also enables the air flow in the first direction and the air flow in the second direction to be generated inside the air blowing tube 100.

Since the inlets of the two blowers 310a and 310b are connected with the connection pipe 340 in the present example, air can be efficiently circulated inside the air flow path 101 airtightly configured.

### [Second Modified Embodiment Related to Air Blow Control]

FIG. 10 is a diagram illustrating a second modification of the air-blow control unit.

An air-blow control unit 300C may have a configuration including the blowers 310a and 310b at one end portion 100a and the other end portion 100b of the air blowing tube 100, respectively. Turning-on/off of the blowers 310a and 310b and the air volume thereof are controlled by the management unit 1000.

When an air flow flowing in a first direction (an arrow-B direction) is to be generated inside the air blowing tube 100 (the first state and the banknote collecting operation state), one blower 310b is turned on to generate an air flow and the other blower 310a is turned off. The blower 310b takes external air to the inside from the inlet and discharges the air, thereby generating the air flow in the arrow-B direction inside the air blowing tube 100. This air flow is taken into the blower 310a from the outlet of the blower 310a and is discharged from the inlet.

When an air flow flowing in a second direction (an arrow-C direction) is to be generated inside the air blowing tube 100 (the second state and the transport body returning state), it suffices to turn one blower 310b off and turn the other blower 310a on to generate the air flow.

Since the present example does not require pipes for causing the air flow path 101 to be a circulation path, the configuration is simplified.

### B. Movement Assistance Mechanism According to Second Invention

A basic configuration and an operation of a movement assistance mechanism applicable to a paper sheet transport system are explained below as a second invention.

### First Embodiment

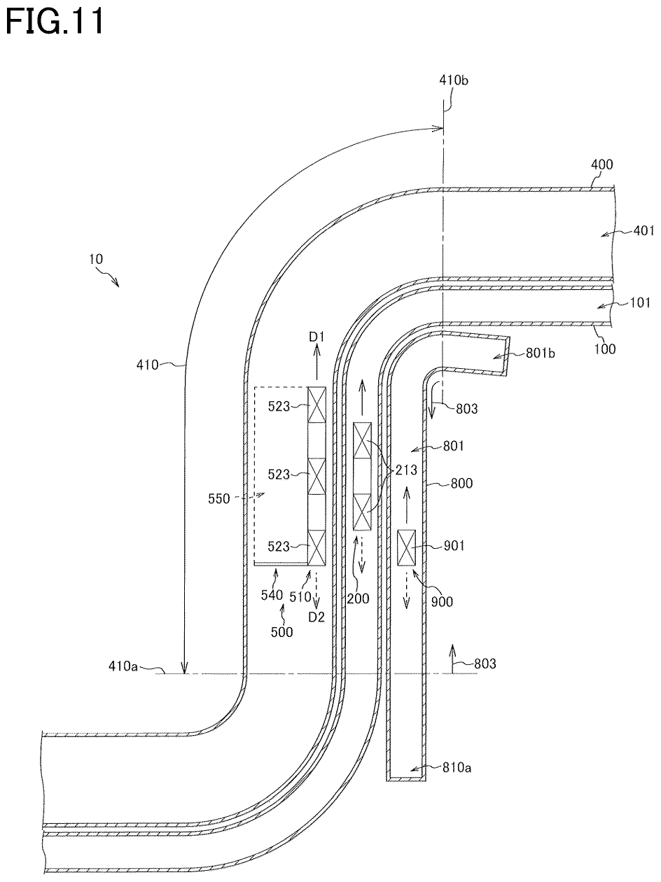

FIG. 11 is a schematic diagram illustrating a transport mechanism according to a first embodiment of the second invention. The transport mechanism according to the present embodiment is characterized in including an assistive body that indirectly assists the transport body with a transport force via the moving body.

In the banknote transport system 10 (the transport mechanism) according to the present embodiment, the transport path 401 includes an assistance-required section 410 in at least a portion. The banknote transport system 10 includes an assistive route 801 that has an assistive force application section 803 arranged adjacent (closely) to and in parallel to a section of the air flow path 101 along the assistance-required section 410, and an assistive body 900 that travels on the assistive route 801.

The assistive route 801 is a course on which the assistive body 900 travels. The assistive route 801 is arranged on the opposite side of the air flow path 101 to the transport path 401.

The assistive route 801 may be configured hermetically (airtightly) or semi-hermitically in the hollow part of a tubular member. The assistive route 801 may be configured in an open manner by a belt, a rail, or the like, or may include a configuration with a portion surrounded by a semicylinder member or the like. The banknote transport system 10 illustrated in the drawing is an example in which an assistive tube 800 that is arranged adjacent to the air blowing tube 100 along the air blowing tube 100 is included, and the hollow part of the assistive tube 800 is used as the assistive route 801.

The assistive body 900 includes an assistive body magnet 901 (an assistive body magnetic material) arranged in an orientation repelling the moving body magnets 213. The assistive body 900 applies an assistive travel force to the moving body 200 as a direct assistance target, using a repelling force based on a magnetic force acting between the assistive body magnet 901 and the moving body magnets 213.

That is, the orientation, arrangement place, and magnetic force intensity of the assistive body magnet 901 included in the assistive body 900, and the orientations, arrangement places, and magnetic force intensities of the moving body magnets 213 included in the moving body 200 as the assistance target are set to enable the assistive body 900 traveling in the assistive force application section 803 to cause a necessary magnetic force to act on the moving body 200. The assistive body 900 indirectly assists the transport force of the transport body 500 via the moving body 200.

### <Assistance-Required Section>

The assistance-required section 410 is a section set to assistively apply a transport force to the transport body 500 directly or indirectly via the moving body 200 to smoothly transport a transport target. In the following explanations, the term of the assistance-required section 410 is used also for a section of the air flow path 101 and a section of the assistive route 801 that run parallel to the assistance-required section 410 in some cases for convenience's sake.

For example, the assistance-required section 410 is a section including a portion in which the travel force of the transport body 500 is reduced when the transport body 500 travels in a specific direction (an arrow-D1 direction in the drawing). Examples of the portion in which the travel force of the transport body 500 is reduced can be a relatively steep upslope portion and a vertical path portion in an upward direction.

The assistive force application section 803 is a section running parallel to the section of the air flow path 101 adjacent to the assistance-required section 410 in the entire range of the assistance-required section 410 in the longitudinal direction. The assistive body 900 travels in the arrow-D1 direction in the assistive force application section 803 to directly assist the travel force of the moving body 200. In the present embodiment, the section of the air flow path 101 to which the assistive force application section 803 runs in parallel is an assisted section in which an assistive travel force is directly applied to the moving body 200 from the assistive body 900.

The distance and positional relation between the assistive force application section 803 and the assisted section in the air flow path 101 are set to enable the assistive body 900 traveling in the assistive force application section 803 to cause a magnetic force to act on the moving body 200 being the assistance target.

The banknote transport system 10 includes a sensor that detects the travel position and speed of the moving body 200 at an appropriate place on the air flow path 101. The management unit 1000 (see FIG. 3) controls the assistive body 900 to be travelled at a predetermined speed in accordance with a timing when the moving body 200 enters the assistance-required section 410 on the basis of a detection output from the sensor, and causes the assistive body 900 to assist the travel force of the moving body 200.

### <Magnet Arrangement Example>

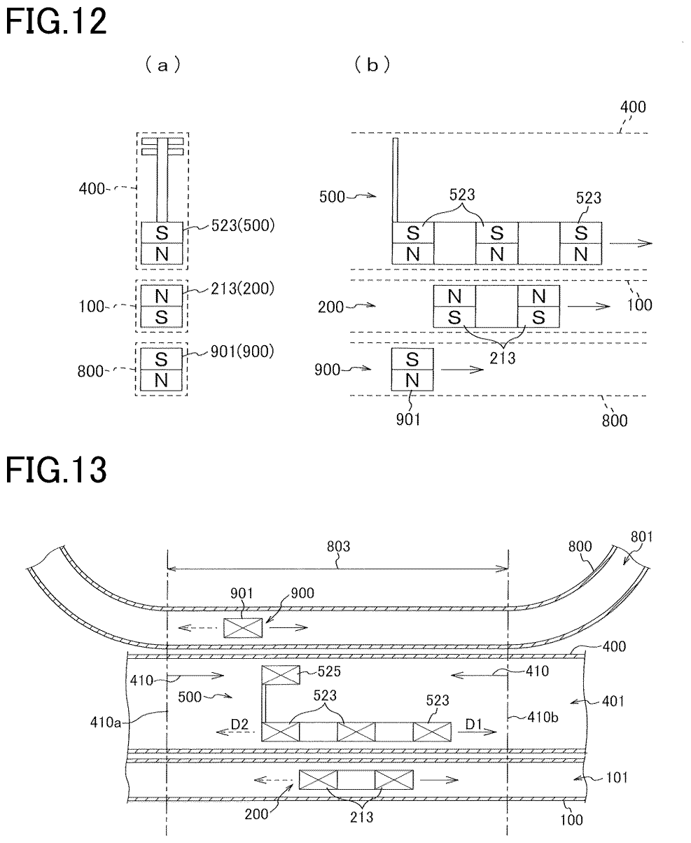

FIGS. 12(a) and 12(b) are schematic diagrams illustrating an arrangement example of magnets.

The present drawings illustrate an example in a case in which the transport body 500 is transported with a repelling force acting between the transport body 500 and the moving body 200, and the moving body 200 is assisted in the travel force with a repelling force acting between the moving body 200 and the assistive body 900. In this configuration, since the moving body is assisted in the travel force using the magnetic force of the moving body magnets 213, a new configuration does not need to be added to the moving body 200 that constitutes “A. Banknote transport system according to first invention”.

The assistive body 900 may include a configuration in which a plurality assistive body magnets 901, 901, . . . are arrayed in the travel direction.

### Second Embodiment

FIG. 13 is a schematic diagram illustrating a transport mechanism according to a second embodiment of the second invention. The transport mechanism according to the present embodiment is characterized in including an assistive body that directly assists the transport force of the transport body. Constituent elements identical to those described above are denoted by like reference signs and explanations thereof are omitted as appropriate.

The banknote transport system 10 according to the present embodiment includes the assistive route 801 that has the assistive force application section 803 arranged adjacent to and in parallel to the assistance-required section 410, and the assistive body 900 that travels on the assistive route 801. The assistive force application section 803 is a section that runs parallel to the assistance-required section 410 in the entire region of the assistance-required section 410 in the longitudinal direction. The assistive route 801 is arranged on the opposite side of the transport path 401 to the air flow path 101. The banknote transport system 10 illustrated in the drawing is an example in which the assistive route 801 is the hollow portion of the assistive tube 800, and includes the assistive tube 800 arranged adjacent to the transport tube 400 along the transport tube 400.

The transport body 500 includes a transport assistance magnet (a transport assistance magnetic material) 525 at an appropriate place near the assistive tube 800.

The assistive body 900 includes the assistive body magnet 901 (the assistive body magnetic material) arranged in an orientation repelling the transport assistance magnet 525. The assistive body 900 directly applies an assistive travel force to the transport body 500 using a repelling force based on a magnetic force acting between the assistive body magnet 901 and the transport assistance magnet 525. The transport body 500 travels while receiving the transport forces from the moving body 200 and the assistive body 900. In the present embodiment, the assistance-required section 410 is an assisted section in which an assistive transport force is directly applied from the assistive body 900 to the transport body 500 being an assistance target.

### <Magnet Arrangement Example>

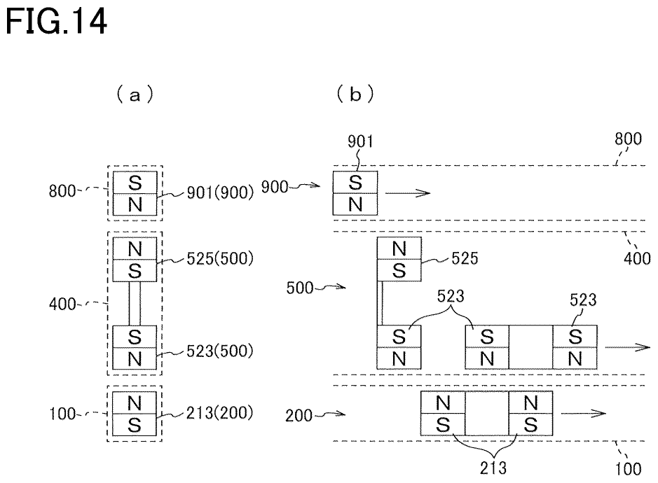

FIGS. 14(a) and 14(b) are schematic diagrams illustrating an arrangement example of magnets.

The present drawings illustrate an example in a case in which the transport body 500 is transported with a repelling force acting between the transport body 500 and the moving body 200, and the transport body 500 is assisted in the travel force with a repelling force acting between the transport body 500 and the assistive body 900. Also with the present example, the travel force of the transport body 500 can be assisted.

### Third Embodiment—Driving Method for Assistive Body

In the first and second embodiments, the assistive body 900 travels on the assistive route 801. Various methods for causing the assistive body 900 applicable to the first and second embodiments to travel are explained below. Hereinafter, a target (the moving body 200 or the transport body 500) that is directly assisted by the assistive body 900 in the travel force is sometimes referred to as an “assistance target” without particular distinction.

### <Reciprocating Drive Example>

In a case in which the assistive body 900 is reciprocatingly driven, the assistive body 900 reciprocates at least in the assistive force application section 803. In the example illustrated in FIG. 11, the assistive body 900 reciprocates in a section from a standby position 801a set outside the assistive force application section 803 near a starting end 410a to a stop position 801b set outside the assistive force application section 803 near a terminating end 410b.

The management unit 1000 causes the assistive body 900 to travel in the direction D1 from the standby position 801a at a predetermined timing according to the travel position and travel speed of the assistance target, to assist travel of the assistance target.

The management unit 1000 can cause the assistive body 900 to travel in a direction D2 from the stop position 801b to be returned to the standby position 801a at a timing when the assistance target is not travelling in the assistance-required section 410.

### <<Air Flow>>

The assistive body 900 may be means that travels on the assistive route 801 using an air flow as a driving force similarly to the moving body 200.

That is, the assistive tube 800 and a blower that generates an air flow in the assistive tube 800 can include substantially the same configurations as those of the air blowing tube 100 and the blowers 310, 310a, and 310b described in the first invention (FIGS. 3, 5, 9, and 10).

In this case, it is desirable that the air blowing tube 100 and the assistive tube 800 are independently configured to prevent air from flowing in and out each other, and that a blower for the assistive tube 800 is included separately from the blower for the air blowing tube 100. This enables the assistive body 900 to travel powerfully and a strong assistive travel force to be applied to the assistance target.

In a case in which the assistive body 900 is caused to travel using an air flow, the assistive body 900 can have a configuration including one or more divided pieces 210 similarly to the moving body 200.

### <<Self-Propelled Type>>

The assistive body 900 may be means that travels on the assistive route 801 by itself. That is, the assistive body 900 can include a power source such as a rechargeable battery, a motor that is driven under power from the power source, wheels rotated by the motor, and the like.

In this case, the assistive tube 800 forming the assistive route 801 does not need to be airtightly configured.

### <<Belt Drive>>

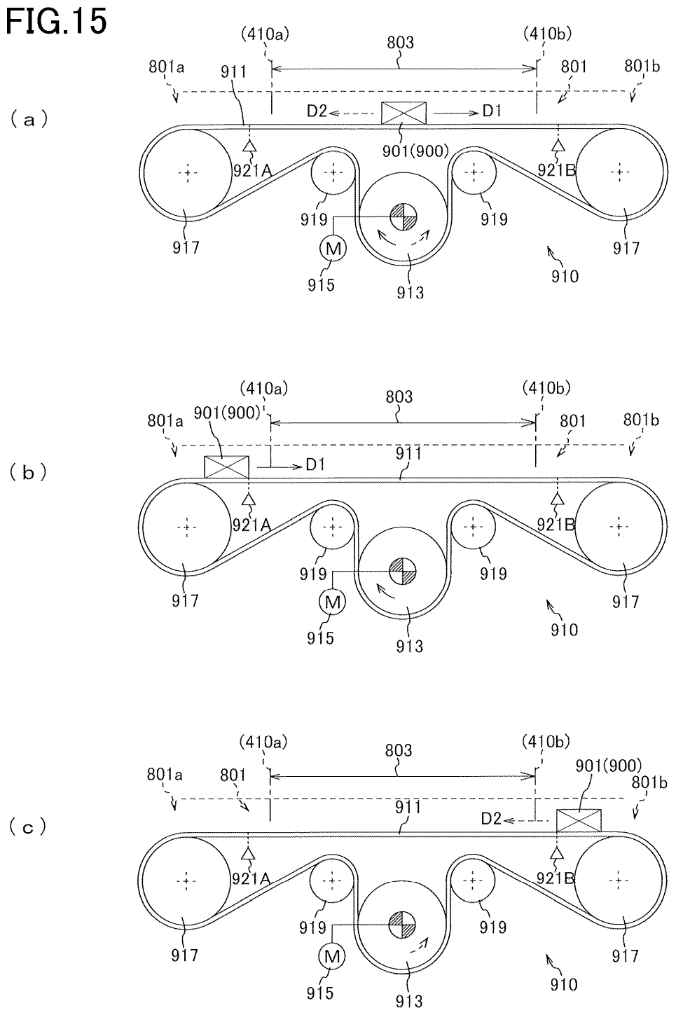

FIGS. 15(a) to 15(c) are schematic diagrams for explaining a drive example of the assistive body.

A drive mechanism 910 that drives the assistive body 900 can include a traveling belt (a retaining member) 911 that has at least a portion extending along the extending direction (the right-left direction in the drawing) of the assistive force application section 803 and that retains the assistive body 900 in at least the assistive force application section 803, and a drive roller (drive means) 913 that drives the traveling belt 911 to cause the assistive body 900 to travel in the assistive force application section 803.

The traveling belt 911 is endless and the assistive body 900 is attached on the outer circumference side. The traveling belt 911 is hung over the drive roller 913 and driven rollers 917 and 917 arranged on the inner circumference side of the traveling belt 911. The drive roller 913 and the driven rollers 917 and 917 are rollers that stretch the traveling belt 911. The drive roller 913 is rotationally driven in forward and reverse directions by a motor (drive means) 915.

The assistive force application section 803 is set between the driven rollers 917 and 917. In other words, the assistive force application section 803 is not set between the drive roller 913 and each of the driven rollers 917.

The traveling belt 911 causes the assistive body 900 to travel in the arrow-D1 direction (a first assistance direction) or the arrow-D2 direction (a second assistance direction) opposite to the arrow-D1 direction in the assistive force application section 803 by rotation of the drive roller 913 in the forward direction indicated by a solid line arrow or the reverse direction indicated by a broken line arrow.

The drive mechanism 910 includes idle rollers 919 and 919 that press the traveling belt 911 from the outer circumferential surface toward the inner circumferential side. The idle rollers 919 and 919 are arranged immediately upstream and immediately downstream of the drive roller 913 with respect to the travel direction of the traveling belt 911. The drive mechanism 910 drives the traveling belt 911 by a central drive method. The idle rollers 919 and 919 apply a predetermined tension to the traveling belt 911. The idle rollers 919 and 919 increase the wrap angles of the traveling belt 911 on the drive roller 913 and the driven rollers 917 and 917. The idle rollers 919 and 919 aid the drive roller 913 in smoothly transmitting the driving force to the traveling belt 911. The idle rollers 919 and 919 enable the driven rollers 917 and 917 to more smoothly rotate when the traveling belt 911 travels.

The drive mechanism 910 includes a first detection sensor 921A that detects arrival of the assistive body 900 at the standby position 801a, and a second detection sensor 921B that detects arrival of the assistive body 900 at the stop position 801b.

The management unit 1000 (see FIG. 3) controls the motor 915 (the drive roller 913) to be rotated in the forward direction at a predetermined speed in accordance with a timing when the assistance target enters the assisted section running parallel to the assistive force application section 803 as illustrated in FIG. 15(b). The management unit 1000 causes the assistive body 900 stopped at the standby position 801a to travel in the arrow-D1 direction at a predetermined speed. Accordingly, the assistive body 900 assists the assistance target in travelling in the assistive force application section 803. The management unit 1000 controls the motor 915 to be stopped when the second detection sensor 921B detects arrival of the assistive body 900 at the stop position 801b.

The management unit 1000 controls the motor 915 (the drive roller 913) to be rotated at a predetermined speed in the reverse direction at a timing when the assistance target is not travelling in the assisted section running parallel to the assistive force application section 803 as illustrated in FIG. 15(c). The management unit 1000 causes the assistive body 900 to travel at a predetermined speed in the arrow-D2 direction. The management unit 1000 controls the motor 915 to be stopped when the first detection sensor 921A detects arrival of the assistive body 900 at the standby position 801a.

In the present example in which the assistive body 900 is driven using the traveling belt 911, the configuration can be simplified because the assistive route 801 does not need to be airtight.

In a case in which the assistive route 801 is curved, the assistive body 900 is caused to travel along the curved assistive route 801 by arranging rollers at appropriate positions or arranging a plurality of drive mechanisms to curve the traveling belt 911 according to the curved shape of the assistive route 801. Since having a flexibility, the endless traveling belt 911 can be curved according to the curved shape of the assistive route 801.

While the traveling belt 911 illustrated in the drawings is a flat belt, a V-belt or a toothed belt may be used as the traveling belt 911.

It suffices that the traveling belt 911 can retain the assistive body 900 and enables the assistive body 900 to reciprocate in the assistive force application section 803. Therefore, the traveling belt may be a member with ends. The traveling belt may be divided into a first traveling belt that draws the assistive body 900 in the arrow-D1 direction, and a second traveling belt that draws the assistive body 900 in the arrow-D2 direction. As the retaining member that retains the assistive body 900 and causes the assistive body 900 to travel in the directions D1 and D2, a linear material such as a wire, a chain, or the like may be used instead of a belt. Drive means that drives the retaining member is appropriately selected according to the form of the retaining member.

The drive mechanism 910 may include a rotary encoder that detects the amount of rotation (the number of rotations, the rotation angle, or the rotation position) of the drive roller 913 instead of the first and second detection sensors 921A and 921B. In this case, the management unit 1000 (see FIG. 3) can determine that the assistive body 900 has reached the standby position 801a or the stop position 801b on the basis of a detection output from the rotary encoder.

### <Circulating Drive Example>

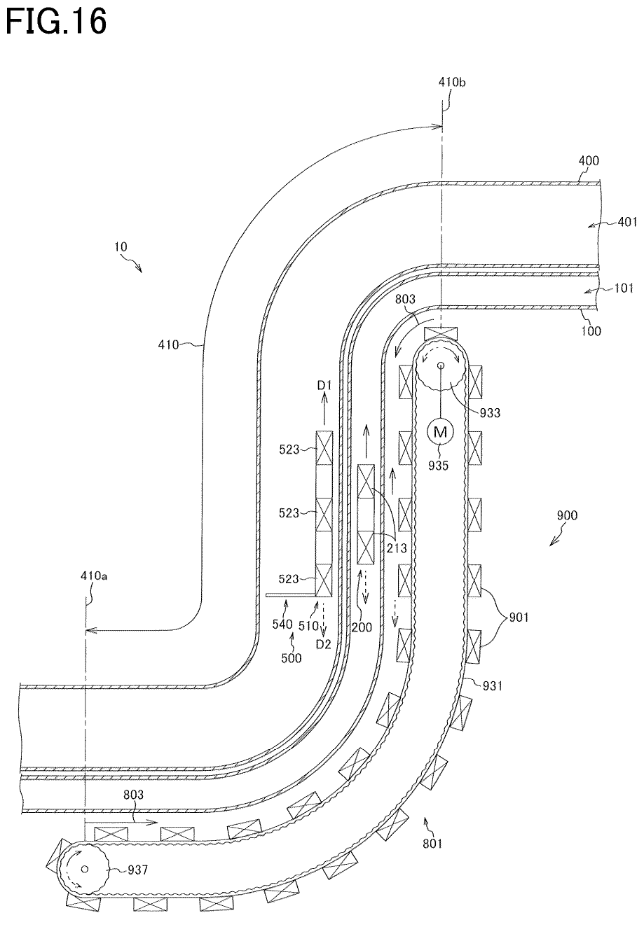

FIG. 16 is a schematic diagram illustrating another configuration and drive example of the assistive body.

The assistive body 900 includes an endless toothed belt (a circulating traveling member) 931 that calculatingly travels on a predetermined route at least in a certain direction (the arrow-D1 direction), and a plurality of the assistive body magnetic materials 901, 901, . . . retained by the toothed belt 931 at predetermined intervals along the travel direction of the toothed belt 931. The travel route of the toothed belt 931 is the endless assistive route 801 including the assistive force application section 803, and the assistive body magnetic materials 901, 901, . . . circulate on the entire assistive route 801.

A drive mechanism that drives the assistive body 900 is configured to include a drive gear 933 that meshes with ribs (teeth) of the toothed belt 931 to transmit a driving force, and a motor 935 that rotationally drives the drive gear 933. The drive mechanism includes a driven gear 937 that meshes with the ribs of the toothed belt 931 at a different site from that of the drive gear 933 as required.

As the circulating traveling member, a chain, a V-belt (one example of a friction transmission belt), or the like can be adopted as well as the toothed belt. In this case, a sprocket that meshes with a chain, a pully around which a V-belt is wound, or the like may be included as means for transmitting a driving force to the circulating traveling member.

In the present drawing, the assistive body 900 is arranged on the opposite side of the air flow path 101 to the transport path 401. The assistive body magnetic materials 901, 901, . . . travel along the air flow path 101 to directly assist the travel of the moving body 200 in the assistive force application section 803.

Since the assistive body 900 is configured to be endless in the present example, high-accuracy drive start timing control over the assistive body 900 with respect to the travel position of the moving body 200 is not required. That is, it suffices that the assistive body 900 is caused to travel at a stage before the moving body 200 enters the assistance-required section 410. The travel speed of the assistive body 900 is determined according to the speed of the moving body 200 traveling in the assistance-required section 410. According to the present example, the drive timing, the travel speed, and the like of the assistive body 900 can be easily controlled.

In the present example, the assistive body does not need to be returned from the stop position to the standby position. It suffices that the assistive body is stopped at a freely-selected timing.

While FIG. 16 illustrates an example in which the assistive body 900 directly assists the travel of the moving body 200, the assistive body 900 may directly assist the travel of the transport body 500. That is the assistive body 900 may be arranged on the opposite side of the transport path 401 to the air flow path 101.

### <Application as Deceleration Means>

For example, in a case in which the assistance-required section 410 is an upslope of a high gradient in the direction D1 as illustrated in FIG. 11, the assistance-required section 410 is a downslope of a high gradient as for the direction D2. Accordingly, in a case in which an assistance target travels in the arrow-D2 direction, the speed of the assistance target is likely to be increased due to the effect of gravity.

When the assistive body 900 travels in the assistive force application section 803 at a relatively lower speed than the travel speed of the assistance target in the case in which the assistance target travels in the direction D2 in the assistance-required section, the assistive body 900 can function as deceleration means that decreases the speed of the assistance target.

The case in which the assistive body 900 travels at a relatively lower speed includes a case in which the assistive body 900 travels in the direction D2, a case in which the assistive body 900 is stopped, and a case in which the assistive body 900 travels in the direction D1. The absolute travel speed (and the travel direction) of the assistive body 900 is appropriately set according to the deceleration effect to be applied to the assistance target, such as the speed at which the assistance target enters the assisted section. In a case in which the assistive body 900 includes a plurality of the assistive body magnets 901, a decelerating force can be applied to the assistance target in the entire range of the assistive force application section 803 in either the case in which the assistive body 900 is stopped or the case in which the assistive body 900 is caused to travel in the direction D1.

### Fourth Embodiment

In the embodiments described above, the travel of the assistance target is assisted by causing the assistive body itself to travel. However, a configuration in which the assistive body itself is not caused to travel may be adopted.

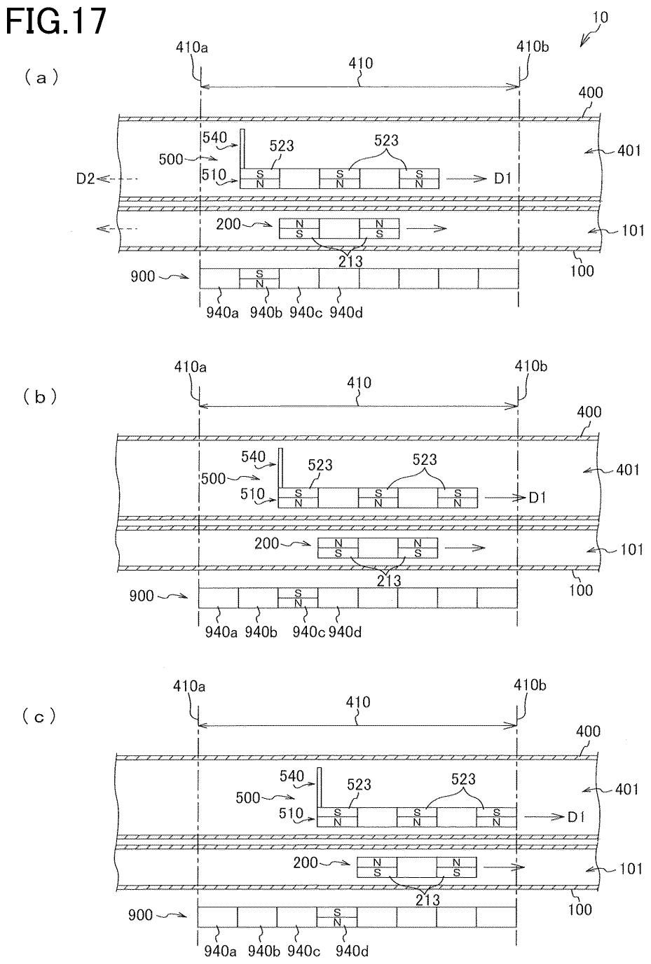

FIGS. 17(a) to 17(c) are schematic diagrams illustrating a first example in which the assistive body is linearly driven. The present example is an example in which the travel of the assistance target is assisted using a linear synchronous drive method. The embodiment is explained below based on an example in which the assistance target is the moving body.

The banknote transport system 10 illustrated in the drawings includes the assistive body 900 fixedly arranged adjacent to a section (an assisted section) of the air blowing tube 100 along the assistance-required section 410. The assistive body 900 includes a plurality of primary coils 940a to 940d . . . (electromagnets) sequentially arrayed in the travel direction of the moving body 200 along the air blowing tube 100. The banknote transport system 10 includes the management unit 1000 (see FIG. 3) that drives and controls the primary coils 940a to 940d . . . , and the assistive body 900 and the management unit 1000 constitute linear drive means.

The assistive body 900 is means that indirectly assists the travel of the transport body 500 via the moving body 200, and is arranged on the opposite side of the air blowing tube 100 to the transport tube 400. Each of the moving body magnets 213 and 213 is arranged in such a manner that one of poles (the S pole in the drawings) is opposed to the assistive body 900.

Each of the primary coils 940a to 940d . . . generates a magnetic force in a direction repelling the moving body magnets 213 and 213.

The management unit 1000 executes control to sequentially turn on/off each of the primary coils 940a to 940d . . . according to the position of the moving body 200 traveling in the assisted section. That is, when the moving body 200 travels in an arrow-D direction at a position illustrated in FIG. 17(a), the management unit 1000 turns on the primary coil 940b and turns off the remaining primary coils. When the moving body 200 travels in the arrow-D1 direction at a position illustrated in FIG. 17(b), the management unit 1000 turns on the primary coil 940c and turns off the remaining primary coils. When the moving body 200 travels in the arrow-D direction at a position illustrated in FIG. 17(c), the management unit 1000 turns on the primary coil 940d and turns off the remaining primary coils.

The management unit 1000 can determine a timing when each of the primary coils 940a to 940d . . . is to be turned on/off on the basis of the speed of the moving body 200 entering the assisted section.

Alternatively, magnetic sensors that detect magnetism generated by the moving body magnets 213 and 213 may be arranged between the primary coils 940a to 940d . . . , and the management unit 1000 may determine a timing when each of the primary coils 940a to 940d . . . is to be turned on/off on the basis of a detection output of each of the magnetic sensors.

The management unit 1000 drives each of the primary coils 940a to 940d . . . to be synchronized with the travel position of the moving body 200 and the speed thereof.

The travel force of the moving body 200 can be assisted by sequential driving of the primary coils 940a to 940d . . . according to the travel position of the moving body 200. That is, one of the primary coils 940a to 940d . . . to be driven is sequentially shifted at a speed corresponding to the speed of the moving body 200.

In a case in which the moving body 200 travels in the arrow-D2 direction, driving power is not supplied to the primary coils 940a to 940d . . . . However, an induced current in a direction to interfere with magnetic fields generated by the moving body magnets 213 and 213 flows in each of the primary coils 940a to 940d . . . . Therefore, the assistive body 900 functions as deceleration means that decelerates the moving body 200.

The poles of the moving body magnets 213 may be arranged alternately in the travel direction. That is, the poles of the magnets included in the moving body 200 may be arranged to be opposed to the assistive body 900 in such a manner that the poles are alternated (as the N pole, the S pole, the N pole, . . . ) along the travel direction. Also in this case, the assistive body 900 can assist the travel of the moving body 200, and can also function as the deceleration means that decelerates the moving body 200.

A configuration in which the assistive body 900 directly assists the travel of the transport body 500 may be adopted.

### Fifth Embodiment

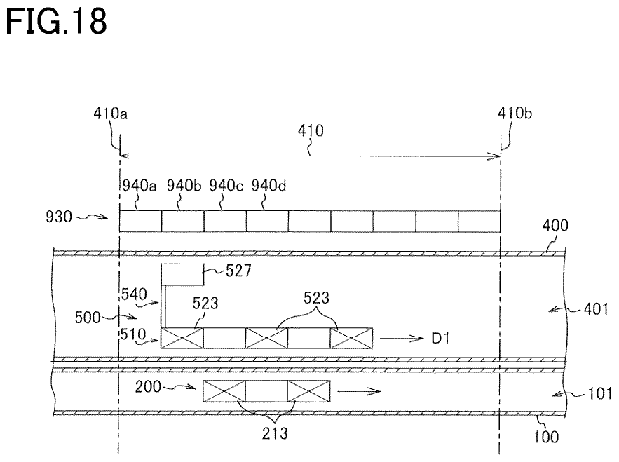

FIG. 18 is a schematic diagram illustrating a second example in which the assistive body is linearly driven. The present example is characterized in that the travel of the transport body is assisted using a linear induction drive method.

The banknote transport system 10 illustrated in the drawing includes the assistive body 900 fixedly arranged adjacent to the transport tube 400 in the assistance-required section 410 (the assisted section). The assistive body 900 includes a plurality of the primary coils 940a to 940c . . . (electromagnets) sequentially arrayed in the travel direction of the moving body 200 along the transport tube 400.

The banknote transport system 10 includes the management unit 1000 (see FIG. 3) that drives and controls the primary coils 940a to 940c . . . , and the assistive body 900 and the management unit 1000 constitute linear drive means.

The assistive body 900 is means that directly assists the travel of the transport body 500 and is arranged on the opposite side of the transport tube 400 to the air blowing tube 100.

The primary coils 940a to 940c are U-phase, V-phase, and W-phase coils, respectively. The assistive body 900 has a configuration in which coils are arranged along the travel direction not to overlap with each other with three coils of the U phase, the V phase, and the W phase as one set.

The transport body 500 described in the present example includes a non-magnetic transport assistance conductor 527. The transport assistance conductor 527 is a secondary conductor for the primary coils 940a to 940c . . . .

The management unit 1000 supplies an alternating current of a frequency according to the speed of the moving body 200 traveling in the assistance-required section 410 to each of the primary coils 940a to 940c . . . . By causing the primary coils 940a to 940c . . . to generate a progressive magnetic field, a thrust force based on an eddy current is generated in the transport assistance conductor 527 to assist the travel force of the transport body 500.

The travel of the transport body 500 may be indirectly assisted via the moving body 200 by arranging a non-magnetic secondary conductor in the moving body 200, and assisting the moving body 200 with the assistive body 900 arranged adjacent to the air blowing tube 100 by the linear induction drive method.

### [Modifications]

In the above embodiments, the banknote transport system 10 has been described as transporting paper sheets. However, objects transported by the banknote transport system 10 are not limited to paper sheets. As one example, it suffices that the transport body 500 has a configuration in which objects as transport targets can be retained by a transport target retaining part 550 that is supported by the transport base 510 as illustrated in FIG. 11.

In the banknote transport system 10, the transport body 500 travels in the transport tube 400 isolated from the external space. Accordingly, the present transport system is suitable as a device that transports transport targets that are desired to be transported without human intervention in terms of safety or other objectives.

While it is desirable that the moving body magnets 213 and the transport body magnets 523 are permanent magnets in terms of downsizing and weight reduction, these magnets may be electromagnets.

The banknote transport system 10 may include a plurality of the assistive bodies 900 that travel in the range of the same assistance-required section 410. For example, it is possible that an assistive body 900 is caused to travel or is driven on the side of the transport tube 400 as well as an assistive body 900 is caused to travel or is driven on the side of the air blowing tube 100.

In the above embodiments, a configuration in which one assistive body 900 is provided in one continuous assistance-required section 410 has been described. However, one continuous assistance-required section may be divided into a plurality of adjacent divided sections to cause one assistive body to travel in each of the divided sections.

The drive mechanism for the assistive body described in the above embodiments can cause the assistive body to travel also in a case in which the assistance-required section is a curbed route. In a case in which the assistance-required section (or a divided section) is constituted only of a linear route, a linear reciprocating motion mechanism such as a rack-and-pinion mechanism or a ball screw mechanism that linearly reciprocates the assistive body may be used as means for driving the assistive body.

The assistive route 801 may be a track such as a rail, or the like.

FIG. 11 illustrates an example in which the assistive tube 800 with ends constitutes the assistive route 801 on which the assistive body 900 is reciprocated. However, an endless (annular) assistive tube 800 may constitute an endless assistive route 801. In this case, the assistive body 900 can be returned to the standby position 801a by causing the assistive body 900 having reached the terminating end 410b of the assistance-required section 410 to continue to travel in the arrow-D1 direction. In a case in which the assistive tube is endless, the assistive body may be caused to travel by an air flow or the assistive body may be self-propelled.

In the above embodiments in which the travel force of the moving body 200 is directly assisted using the assistive body 900, a configuration in which the travel force of the moving body 200 is assisted using the magnetic force of the moving body magnets 213 has been described. However, the moving body 200 may include a dedicated magnet (a movement assistance magnet, a movement assistance magnetic material) for receiving an assistive travel force from the assistive body 900 besides the moving body magnets 213. In this case, the assistive body 900 applies an assistive travel force to the moving body as the assistance target using a repelling force or/and an attracting force based on a magnetic force acting between the assistive body magnet 901 and the movement assistance magnet.

In the banknote transport system 10, arrangement of the assistive body magnet 901 and the magnets included in the moving body 200 can be different from the arrangement described in the above embodiments as long as these magnets are in a positional relation in which an assistive transport force can be applied from the assistive body 900 to the moving body 200. The positional relation between the assistive route 801 and the air flow path 101 is appropriately set according to the arrangement. The same holds for the positional relations between the assistive body 900 and the transport body 500, and between the assistive route 801 and the transport path 401.

### [Summary of Aspect Examples, Actions, and Effects of Present Invention]

A transport mechanism (the banknote transport system 10) according to each aspect of the present invention described below includes the moving body 200 that has a moving body magnetic material (the moving body magnets 213) and that travels on a moving route (the air flow path 101), and the transport body 500 that has the transport target retaining part 550 retaining a transport target (a banknote P) and a transport body magnetic material (the transport body magnets 523) and that is transported on a transport route (the transport path 401) adjacent and parallel to the moving route in conjunction with travel of the moving body using at least a repelling force based on a magnetic force acting between the transport body magnetic material and the moving body magnetic material.

The transport route includes the assistance-required section 410 in at least a portion thereof. The assistance-required section is a section in which the travel force of the transport body 500 is reduced, or the like and is a section set in such a manner that a transport force is assistively applied to the transport body directly or indirectly via the moving body in the section.

### <First Aspect>

The transport mechanism (the banknote transport system 10, FIG. 11) according to the present aspect includes the assistive force application section 803 arranged adjacent to a section of a moving route (the air flow path 101) along the assistance-required section 410, and the assistive body 900 that travels in the assistive force application section. The assistive body includes an assistive body magnetic material (the assistive body magnet 901), and applies an assistive travel force to the moving body 200 as an assistance target using a repelling force or/and an attracting force based on a magnetic force acting between the assistive body magnetic material and a moving body magnetic material (the moving body magnets 213).

In the present aspect, since the assistive body indirectly assists the transport force of a transport body via the moving body, the transport body can smoothly transport a transport target in the assistance-required section. Since the assistive force application section is arranged partially in a section that requires assistance on a transport route, an increase in the entire cost of the transport mechanism can be prevented. Furthermore, it is possible to flexibly address a layout change or the like of the transport route. Particularly in the present aspect, since an assistive travel force is applied to the moving body using the moving body magnetic material used when the transport body is magnetically transported, a special alteration does not need to be performed to the moving body.

### <Second Aspect>

The transport mechanism (the banknote transport system 10, FIG. 13) according to the present aspect includes the assistive force application section 803 arranged adjacent to the assistance-required section 410, and the assistive body 900 that travels in the assistive force application section. The transport body 500 includes a transport assistance magnetic material (the transport assistance magnet 525), and the assistive body includes an assistive body magnetic material (the assistive body magnet 901) and applies an assistive travel force to the transport body as an assistance target using a repelling force or/and an attracting force based on a magnetic force acting between the assistive body magnetic material and the transport assistance magnetic material.

The present aspect provides the same effects to a configuration common or similar to that of the first aspect.

Particularly in the present aspect, the assistive body directly assists the transport force of the transport body. Therefore, a transport target can be smoothly transported in the assistance-required section. Since the transport body includes a dedicated transport assistance magnetic material that receives the assistive travel force, the transport body can reliably obtain a necessary assistive force from the assistive body. The degree of freedom in arrangement of each magnetic material in the transport body can be enhanced. Furthermore, the position (or direction) of the assistive force application section with respect to the transport route can be flexibly set according to the position of the transport assistance magnetic material in the transport body.

### <Third Aspect>

In the transport mechanism (the banknote transport system 10) according to the present aspect, the assistive force application section 803 is arranged in a tube body (the assistive tube 800) through which a fluid flows in a predetermined direction, and the assistive body 900 travels in the assistive force application section while receiving energy from the fluid.

The fluid is not limited to a particular type. However, when the fluid is air, handling is easy and configurations of components can be simplified. In a case in which the assistive body travels while receiving an air flow, a tube body airtightly configured and a blower that generates an air flow in the tube body are needed. In a case in which the moving body and the assistive body are both means that travel while receiving an air flow, it is desirable that a tube body and a blower for the assistive body are of a separate system from that of a tube body and a blower for the moving body.

### <Fourth Aspect>

In the transport mechanism (the banknote transport system 10) according to the present aspect, the assistive body 900 includes drive means that travels by itself in the assistive force application section 803.

For example, the assistive body can include wheels for traveling in the assistive force application section, and a power source, an electric motor, and the like as drive means that drive the wheels. In this case, the assistive force application section does not need to be airtightly configured.

### <Fifth Aspect>

The transport mechanism (the banknote transport system 10, FIG. 15) according to the present aspect includes a retaining member (the traveling belt 911) that has at least a portion extending along an extending direction of the assistive force application section 803 and that retains the assistive body 900 in at least the assistive force application section, and drive means (the drive roller 913, the motor 915) that drives the retaining member to cause the assistive body to travel in the assistive force application section.

The present example is an example in which the assistive body is reciprocated in the assistance-required section 410.

It suffices that the retaining member can retain the assistive body and can reciprocate the assistive body in the assistive force application section by traveling itself. Therefore, a linear material such as various belts or wires, a chain, or the like can be used as the retaining member.

The retaining member may be constituted of an endless belt. In this case, one of rollers that stretch the endless belt is a drive roller that drives the endless belt. By causing the endless belt to rotationally travel at a speed according to the travel speed of an assistance target, the travel of the assistance target can be assisted via the assistive body.

### <Sixth Aspect>

In the transport mechanism (the banknote transport system 10, FIG. 16) according to the present aspect, the assistive body 900 includes an endless circulating traveling member (the toothed belt 931), and a plurality of the assistive body magnetic materials 901, 901, . . . retained by the circulating traveling member at predetermined intervals along a travel direction of the circulating traveling member. The assistive body circulatingly travels in an endless section including the assistive force application section 803.

According to the present aspect, drive and stop timings of the assistive body, a travel speed thereof, and the like are easily controlled.

### <Seventh Aspect>

The transport mechanism (the banknote transport system 10, FIG. 17) according to the present aspect includes linear drive means including the assistive body 900 that is adjacent to a section of a moving route (the air flow path 101) along the assistance-required section 410 and that has a plurality of the primary coils 940a to 940d . . . sequentially arranged along a section of the moving route, and drive means (the management unit 1000) that sequentially drives the primary coils according to the speed of the moving body 200, a moving body magnetic material (the moving body magnets 213) is a permanent magnet, and the linear drive means applies an assistive travel force to the moving body based on a magnetic force acting between the primary coils and the moving body magnetic material.

In the present aspect, the assistive body indirectly assists the transport force of a transport body via the moving body. Therefore, a transport target can be smoothly transported in the assistance-required section. Since the assistive body is arranged partially in a section of a transport route where the assistance is required, an increase in the entire cost of the transport mechanism can be prevented. Furthermore, a layout change of the transport route or the like can be easily addressed. Since the assistive body does not travel, facilities related to the assistive body can be compact.

Particularly in the present aspect, an assistive travel force is applied to the moving body using the moving body magnetic material that is used when the transport body is magnetically transported. Therefore, a special alteration does not need to be performed to the moving body.

### <Eighth Aspect>

The transport mechanism (the banknote transport system 10) according to the present aspect includes linear drive means including the assistive body 900 that is adjacent to the assistance-required section 410 and that has a plurality of the primary coils 940a to 940d . . . sequentially arranged along the assistance-required section, and drive means (the management unit 1000) that sequentially drives the primary coils according to the speed of the transport body 500, the transport body includes a transport assistance magnetic material (the transport assistance magnet 525) being a permanent magnet, and the linear drive means applies an assistive travel force to the transport body based on a magnetic force acting between the primary coils and the transport assistance magnetic material.

The present aspect provides the same effects to a configuration common or similar to that of the seventh aspect.

Since the assistive body directly assists the transport force of the transport body, a transport target can be smoothly transported in the assistance-required section. The transport body includes a dedicated transport assistance magnetic material that receives an assistive travel force. Therefore, the transport body can reliably obtain a necessary assistive force from the assistive body. The degree of freedom in arrangement of each magnetic material in the transport body can be enhanced. Furthermore, the position (or direction) of the assistive body with respect to the transport route can be flexibly set according to the position of the transport assistance magnetic material in the transport body.

### <Ninth Aspect>

The transport mechanism (the banknote transport system 10, FIG. 18) according to the present aspect includes linear drive means including the assistive body 900 that is adjacent to the assistance-required section 410 and that has a plurality of the primary coils 940a to 940c . . . sequentially arranged along the assistance-required section, and drive means (the management unit 1000) that drives each of the primary coils based on a frequency and a voltage according to the speed of the transport body 500, the transport body includes a non-magnetic secondary conductor (the transport assistance conductor 527), and the linear drive means applies an assistive travel force to the transport body based on an induced current generated in the secondary conductor by the primary coil.

The present aspect provides the same effects to a configuration common or similar to that of the eighth aspect.

Since the assistive body directly assists the transport force of the transport body, a transport target can be smoothly transported in the assistance-required section.

Since the transport body includes a dedicated secondary conductor that receives the assistive travel force, the transport body can reliably obtain a necessary assistive force from the assistive body. The secondary conductor is a non-magnetic material. Therefore, a braking force arising from occurrence of an induced current does not act and does not become a cause of speed reduction in a state in which the primary coils are not driven. The degree of freedom in arrangement of each magnetic material in the transport body can be enhanced. Furthermore, the position (or direction) of the assistive body with respect to the transport route can be flexibly set according to the position of the transport assistance magnetic material in the transport body.

### REFERENCE SIGNS LIST

L . . . bank facility, P . . . banknote (transport target), 1 . . . game machine, L . . . bank 2 . . . sandwiched machine, 10 . . . banknote transport system (transport mechanism), 100 . . . air blowing tube (pipe), 101 . . . air flow path (first route, moving route), 110 . . . first air blowing tube, 111 . . . moving route part, 120 . . . second air blowing tube, 200 . . . moving body, 210 . . . divided piece, 211 . . . hinge part, 213 . . . moving body magnet (first magnet, first magnetic material, moving body magnetic material), 300 . . . air-blow control unit, 310 . . . blower, 320 . . . switching unit, 321 . . . casing, 323 . . . flow path, 325 . . . switching valve, 330 . . . first circulation pipe, 330a . . . one end portion, 330b . . . the other end portion, 331 . . . air discharge tube, 333 . . . air intake tube, 340 . . . connection pipe, 400 . . . transport tube (pipe), 401 . . . transport path (second route, transport route), 402 . . . base transport path, 403 . . . banknote transport path, 410 . . . assistance-required section, 410a . . . starting end, 410b . . . terminating end, 500 . . . transport body, 510 . . . transport base, 520 . . . divided piece, 521 . . . hinge part, 523 . . . transport body magnet (second magnet, second magnetic material, transport body magnetic material), 525 . . . transport assistance magnet (transport assistance magnetic material), 527 . . . transport assistance conductor (secondary conductor), 540 . . . banknote collecting/retaining part, 541 . . . support member, 544 . . . collecting member, 550 . . . transport target retaining part, 600 . . . receiving unit, 700 . . . cashbox unit, 800 . . . assistive tube, 801 . . . assistive route, 801a . . . standby position, 801b . . . stop position, 803 . . . assistive force application section, 900 . . . assistive body, 901 . . . assistive body magnet (assistive body magnetic material), 910 . . . drive mechanism, 911 . . . traveling belt (retaining member), 913 . . . drive roller (drive means), 915 . . . motor (drive means), 917 . . . driven roller, 919 . . . idle roller, 921 . . . detection sensor, 931 . . . toothed belt (circulating traveling member), 933 . . . drive gear, 935 . . . motor, 937 . . . driven gear, 940a to 940d . . . primary coil, 1000 . . . management unit, 1001 . . . housing

1. A transport mechanism comprising:
a moving body that has a moving body magnetic material and that travels on a moving route;
a transport body that has a retaining part retaining a transport target and a transport body magnetic material, and that is transported on a transport route adjacent and parallel to the moving route in conjunction with travel of the moving body using at least a repelling force based on a magnetic force acting between the transport body magnetic material and the moving body magnetic material;
an assistance-required section set in at least a portion of the transport route;
an assistive force application section arranged adjacent to a section of the moving route along the assistance-required section; and
an assistive body that travels in the assistive force application section, wherein
the assistive body includes an assistive body magnetic material, and applies an assistive travel force to the moving body as an assistance target using a repelling force or/and an attracting force based on a magnetic force acting between the assistive body magnetic material and the moving body magnetic material.

2. A transport mechanism comprising:
a moving body that has a moving body magnetic material and that travels on a moving route;
a transport body that has a retaining part retaining a transport target and a transport body magnetic material, and that is transported on a transport route adjacent and parallel to the moving route in conjunction with travel of the moving body using at least a repelling force based on a magnetic force acting between the transport body magnetic material and the moving body magnetic material;
an assistance-required section set in at least a portion of the transport route;
an assistive force application section arranged adjacent to the assistance-required section; and
an assistive body that travels in the assistive force application section,
wherein the transport body includes a transport assistance magnetic material, and
wherein the assistive body includes an assistive body magnetic material, and applies an assistive travel force to the transport body as an assistance target using a repelling force or/and an attracting force based on a magnetic force acting between the assistive body magnetic material and the transport assistance magnetic material.

3. The transport mechanism according to claim 1, wherein the assistive force application section is arranged in a tube body through which a fluid flows in a predetermined direction, and
wherein the assistive body travels in the assistive force application section while receiving energy from the fluid.

4. The transport mechanism according to claim 1, wherein the assistive body includes drive means that travels by itself in the assistive force application section.

5. The transport mechanism according to claim 1, comprising:
a retaining member that has at least a portion extending along an extending direction of the assistive force application section, and that retains the assistive body in at least the assistive force application section, and
drive means that drives the retaining member to cause the assistive body to travel in the assistive force application section.

6. The transport mechanism according to claim 2, wherein the assistive force application section is arranged in a tube body through which a fluid flows in a predetermined direction, and
wherein the assistive body travels in the assistive force application section while receiving energy from the fluid.

7. The transport mechanism according to claim 2, wherein the assistive body includes drive means that travels by itself in the assistive force application section.

8. The transport mechanism according to claim 2, comprising:
a retaining member that has at least a portion extending along an extending direction of the assistive force application section, and that retains the assistive body in at least the assistive force application section, and
drive means that drives the retaining member to cause the assistive body to travel in the assistive force application section.
